(19) United States
(12) Patent Application Publication
(10) Pub. No.: US 2024/0121798 A1
(43) Pub. Date: Apr. 11, 2024

(54) METHODS, APPARATUS AND SYSTEMS FOR A CONTROL CHANNEL MONITORING PROCEDURE

(71) Applicant: ZTE Corporation, Shenzhen (CN)

(72) Inventors: Qiujin GUO, Shenzhen (CN); Mengzhu CHEN, Shenzhen (CN); Jun XU, Shenzhen (CN); Xiaoying MA, Shenzhen (CN); Yuzhou HU, Shenzhen (CN); Xuan MA, Shenzhen (CN)

(73) Assignee: ZTE Corporation, Shenzhen (CN)

(21) Appl. No.: 18/353,004

(22) Filed: Jul. 14, 2023

Related U.S. Application Data
(63) Continuation of application No. PCT/CN2021/072056, filed on Jan. 15, 2021.

(51) Int. Cl. H04W 72/232; H04W 72/0446; H04W 72/0457; H04W 72/51

(52) U.S. Cl. CPC H04W 72/232; H04W 72/0446; H04W 72/0457; H04W 72/51

(57) ABSTRACT

Systems, methods and devices for control channel monitoring may include a wireless communication device receiving, from a wireless communication node, a plurality of parameters. The wireless communication device may perform, responsive to a trigger event, a PDCCH monitoring behavior comprising at least one of PDCCH monitoring according to a search space set (SSS) group from N SSS groups or skipping of PDCCH monitoring according to a skipping period, based on the plurality of parameters. The parameter N may be an integer greater than or equal to two and less than or equal to ten. The skipping period may be determined from one or more candidate skipping periods.

### CROSS-REFERENCE TO RELATED APPLICATION

This application claims the benefit of priority under 35 U.S.C. § 120 as a continuation of PCT Patent Application No. PCT/CN2021/072056, filed on Jan. 15, 2021, the disclosure of which is incorporated herein by reference in its entirety.

### TECHNICAL FIELD

The disclosure relates generally to wireless communications, including but not limited to methods, devices and systems for control channel monitoring.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

Embodiments described herein provide solutions for the technical problem of improving control channel monitoring, at least with respect to power consumption. A wireless communication node may transmit, and a wireless communication device (also referred to herein as UE) may receive, parameters or control information, such as DCI or a timer to trigger or perform a specific control channel (e.g., PDCCH) monitoring behavior, for example, among a plurality of supported monitoring behaviors. The wireless communication device may support PDCCH monitoring switching among one or more search space set (SSS) groups and PDCCH skipping during a skipping period. The number of SSS groups may be equal to N. The parameter N may not be smaller than 2 and may not be larger than 10. The different values of a skipping period may not be smaller than 1 value (of any unit).

The wireless communication device may start a default PDCCH monitoring behavior after a PDCCH monitoring behavior. The PDCCH monitoring behavior may include at least one of PDCCH monitoring according to a SSS group with a specific group index, the end of a skipping period, a timer expires, PDCCH monitoring according to a SSS, RRC configuration, RRC reconfiguration of SSS switching parameter and/or PDCCH skipping parameter.

The default PDCCH monitoring behavior or default SSS group may be determined based on at least one of the parameters including
a search space switching configuration related to a user equipment (UE) capability,
a PDCCH skipping configuration related to a UE capability,
a higher layer parameter used to enable SSS group switching,
a higher layer parameter used to enable PDCCH skipping,
a search space set group index configuration,
a PDCCH skipping parameter that is set to configure the wireless communication device to perform skipping of PDCCH monitoring,
a search space switching parameter that is set to configure the wireless communication device to perform search space set group switching,
a timer for search space switching,
a timer for PDCCH monitoring behavior switching,
a skipping period configuration,
a discontinuous reception (DRX) configuration,
a frequency band comprising at least one of: FR1, FR2, or an unlicensed band,
a transmission mode comprising at least one of: dynamic downlink (DL) scheduling, dynamic uplink (UL) scheduling, semi-persistent scheduling physical downlink shared channel (PDSCH), UL transmission without dynamic grant, quasi-periodic DL data scheduling with jitter, quasi-periodic UL data scheduling with jitter, or UL grant scheduling, or
a quality of service (QoS) parameter, or
a downlink control information (DCI) format comprising at least one of: DCI format 2-0, DCI format 0-1, DCI format 0-2, DCI format 1-1, DCI format 1-2, or DCI format 2-6.

The UE capability may comprise an indication of whether the wireless communication device supports at least one of:
switching among N groups of search space sets with a DCI format monitoring, where N is not less than 2;
skipping PDCCH monitoring during the skipping period with a DCI format monitoring,
monitoring of a DCI format with a search space set switching field or a PDCCH skipping field,
at least a timer to switch to performing skipping PDCCH monitoring during a skipping period,
at least a timer to switch back to an original search space set group,
switching a search space set group with PDCCH decoding to a group other than group 0,
switching search space set groups for different cells independently, unless the wireless communication device supports search space switching for a set of cells, or
skipping PDCCH monitoring during the skipping period for different cells independently, unless the wireless communication device supports skipping PDCCH monitoring for a set of cells.

A UE capability for supporting switching among N groups of search space sets and a UE capability for supporting skipping PDCCH monitoring may not be enabled simultaneously.

The skipping flag field in a DCI is used to enable the wireless communication device to perform PDCCH skipping, if the PDCCH skipping parameter is configured for the wireless communication device. The skipping flag field in a DCI is used to enable the wireless communication device to perform search space set group switching, if the search space switching parameter is configured for the wireless communication device. The skipping flag field may be at least 1 bit if the higher layer parameter related to PDCCH skipping or search space switching is configured.

The search space set group index indication field can be used to indicate the search space set group index, if the search space switching parameter is configured for the wireless communication device, the skipping flag is set to enable the UE to perform SSS group switching, and/or the number of different search space set group index is larger than 1. The search space set group index indication field can be used to indicate the skipping period, if the PDCCH skipping parameter is configured for the wireless communication device, and/or the skipping flag is set to enable the UE to perform PDCCH skipping, and/or the number of different values of skipping period is larger than 1.

The UE can perform PDCCH skipping by setting the duration parameter of search space set as 0 slot, or by stopping monitoring PDCCH during a skipping period.

The skipping period can be at least one of a smallest PDCCH monitoring periodicity or a largest PDCCH monitoring periodicity in the unit of slot among all of the search space sets in a SSS group, or a timer used for search space set switching in the unit of millisecond, or a duration configured by RRC signaling.

The PDCCH skipping may be configured for all BWPs in a cell or serving cells in a cell group. The skipping period may be counted/determined according to a reference SCS configuration. The reference SCS may be the smallest SCS configuration among all BWPs in the serving cell or all serving cells in a cell group.

During the time where the skipping period overlapped with drx-RetransmissionTimerDL and/or drx-RetransmissionTimerUL, the UE can keep monitoring PDCCH scheduling data for retransmission which is not received successfully before receiving the PDCCH skipping indication, if the higher-layer parameter associated with it (retransmission period) is configured.

During a specific duration, the wireless communication device can perform PDCCH monitoring for a scheduling retransmission data after a trigger event. Wherein the trigger event is used to trigger the wireless communication device to perform PDCCH skipping or search space set group switching.

The specific duration can be related to at least one of:
the skipping period, or
a drx-RetransmissionTimerDL timer, or
a drx-RetransmissionTimerUL timer, or
a timer used for detecting a PDCCH for a scheduling retransmission data, or
a discontinuous reception (DRX) configuration, or
a maximum number of data retransmission or repetition.

The specific duration can start after occurrence of a triggering event indicating skipping of PDCCH monitoring or search space set group switching, and can extend to a time when data for retransmission is received successfully by the wireless communication device. The wireless communication device performs skipping of PDCCH monitoring or search space set group switching after the end of the specific duration.

The specific duration can represent the overlap between the skipping period and at least one duration during which at least one of a drx-RetransmissionTimerDL timer or a drx-RetransmissionTimerUL timer is running when discontinuous reception (DRX) is configured. The wireless communication device does not expect to monitor PDCCH with data scheduling for initial transmission after detecting a PDCCH with PDCCH skipping indication.

There is no timer to be reset when the wireless communication device switches monitoring PDCCH to PDCCH skipping. There are at least two timers to be reset when the wireless communication device switches monitoring PDCCH according to a first search space set group to monitor PDCCH according to a second search space set group if N is larger than 2. The group index of the second search space set group is smaller than the maximum group index configured by higher layer parameter. At least one timer is used to count the number of slots. At least one timer is used to count the PDCCH monitoring occasions. At least one timer is used to count the number of slot or PDCCH monitoring occasions where the wireless communication device does not monitor PDCCH.

The PDCCH monitoring behavior when the UE starts monitoring PDCCH according to the search space set group with group index i can indicate that the wireless communication device is to stop monitoring PDCCH during a skipping period. The skipping period may be the maximum or minimum PDCCH monitoring periodicity ks of all of the search space sets in search space set group with group index i, and/or determined by a timer. The wireless communication device may stop decrementing any timer for search space set group switching during a skipping period. The search space set group with group index i is a predefined SSS group configured per BWP, or per cell, or per cell group. Wherein the wireless communication device does not monitor PDCCH according to the predefined SSS group. The timer is decremented after each slot when the UE monitors PDCCH according to the search space set group with group index i. The UE starts monitoring PDCCH according to a search space set group after the skipping period.

If the wireless communication device is not need to perform BWP switching during the delay, the delay can be determined based on predefined minimum delay values 1 and 2 representing UE processing capabilities 1 and 2, respectively, and equal to values for wireless communication device supporting NR-U.

If the wireless communication device is to perform BWP switching during the delay, the delay can be determined as the maximum value of the delay in Table 1 and BWP switching delay in Table 2 configured by higher layer parameters according to the reference SCS configuration. The reference SCS configuration can be determined by the smaller SCS between a first SCS before BWP switch and a second SCS after BWP switch. The search space set group switching can be indicated by DCI format 2-6, and the PDCCH skipping or the predefined SSS group cannot be indicated by DCI format 2-6.

At least one aspect is directed to a system, method, apparatus, or a computer-readable medium. A wireless communication device may receive, from a wireless communication node, a plurality of parameters. The wireless communication device may perform, responsive to a trigger event, a PDCCH monitoring behavior comprising at least one of PDCCH monitoring according to a search space set (SSS) group from N SSS groups or skipping of PDCCH monitoring according to a skipping period, based on the plurality of parameters. The parameter N may be an integer greater than or equal to 2 and less than or equal to 10. The skipping period may be determined from one or more candidate skipping periods.

In some embodiments, the plurality of parameters may include at least one of (i) a search space switching configuration related to a user equipment (UE) capability, (ii) a PDCCH skipping configuration related to a UE capability, (iii) a higher layer parameter used to enable SSS group switching, (iv) a higher layer parameter used to enable PDCCH skipping, (v) a search space set group index configuration, (vi) a PDCCH skipping parameter that is set to configure the wireless communication device to perform skipping of PDCCH monitoring, (vii) a search space switching parameter that is set to configure the wireless communication device to perform search space set group switching, (viii) a timer for search space switching, (ix) a timer for PDCCH monitoring behavior switching, (x) a skipping period configuration, (xi) a discontinuous reception (DRX) configuration, (xii) a frequency band comprising at least one of: FR1, FR2, or an unlicensed band, (xiii) a transmission mode comprising at least one of dynamic downlink (DL) scheduling, dynamic uplink (UL) scheduling, semi-persistent scheduling physical downlink shared channel (PDSCH), UL transmission without dynamic grant, quasi-periodic DL data scheduling with jitter, quasi-periodic UL data scheduling with jitter or UL grant scheduling, or (xiv) a quality of service (QoS) parameter, or (xv) a downlink control information (DCI) format comprising at least one of: DCI format 2-0, DCI format 0-1, DCI format 0-2, DCI format 1-1, DCI format 1-2 or DCI format 2-6.

The UE capability may include an indication of whether the wireless communication device supports at least one of (i) switching among N groups of search space sets with a DCI format monitoring, where N is not less than 2, (ii) skipping PDCCH monitoring during the skipping period with a DCI format monitoring, (iii) monitoring of a DCI format with a search space set switching field or a PDCCH skipping field, (iv) at least a timer to switch to performing skipping PDCCH monitoring during a skipping period, (v) at least a timer to switch back to an original search space set group, (vi) switching a search space set group with PDCCH decoding to a group other than group 0, (vii) switching search space set groups for different cells independently, unless the wireless communication device supports search space switching for a set of cells, or (viii) skipping PDCCH monitoring during the skipping period for different cells independently, unless the wireless communication device supports skipping PDCCH monitoring for a set of cells. A UE capability for supporting switching among N groups of search space sets and a UE capability for supporting skipping PDCCH monitoring may not be enabled simultaneously.

In some embodiments, the parameter N may be related to at least one of a downlink control information (DCI) format that can indicate SSS group switching, DCI format 2-0 that can indicate 2 SSS groups, or at least one of DCI format 0-1, DCI format 1-1, DCI format 0-2 or DCI format 1-2 that can indicate at least 2 SSS groups. In some embodiments, performing the PDCCH monitoring behavior may include the wireless communication device performing PDCCH monitoring according to a search space set group, or the wireless communication device stopping PDCCH monitoring during a skipping period.

In some embodiments, the trigger event may include at least one of (i) the wireless communication device being provided at least one of the plurality of parameters, (ii) a time occurring after the end or a last slot or symbol of the skipping period, (iii) receiving radio resource control (RRC) configuration, (iv) receiving RRC reconfiguration of SSS group switching, (v) successfully receiving a data that is scheduled by a DCI indicating the change of PDCCH monitoring behavior, (vi) reporting an acknowledgement (ACK), (vii) the wireless communication device receiving, from the wireless communication node, a signaling indicative of the change of PDCCH monitoring behavior, or (viii) occurrence of a predefined condition related to a timer at the wireless communication device. The predefined condition may comprise at least one of the timer expiring when the wireless communication device is performing PDCCH monitoring according to a SSS group, or the wireless communication device detecting a PDCCH when the timer is running or decremented. The timer may be reset when the wireless communication device performs a change to the PDCCH monitoring behavior, may be reset after a last slot or symbol of the skipping period, may expire when a value configured by a higher layer parameter is reached after the timer increments by one after each detection of a PDCCH by the wireless communication device, or may expire when a value of 0 is reached after the timer decrements by one after each slot.

In some embodiments, the wireless communication device may determine that the signaling includes a downlink control information (DCI) indication. The DCI indication may include at least one of a skipping flag field or a search space set group index indication field. The skipping flag field may be to at least one of enable or disable the wireless communication device to perform skipping of PDCCH monitoring if a higher layer parameter which is related to PDCCH skipping configuration is configured, enable the wireless communication device to stop PDCCH monitoring during a skipping period if the higher layer parameter which is related to the PDCCH skipping configuration is configured, or enable or disable the wireless communication device to perform search space set group switching if a higher layer parameter which is related to search space set switching is configured. The search space set group index indication field may be to indicate at least one of a search space set group index or the skipping period. The DCI indication may include at least one of a PDCCH skipping indication field, a search space switching indication field, or a search space set group index if the higher layer parameter which is related to search space switching configuration is configured. The PDCCH skipping indication field may be to at least one of enable or disable the wireless communication device to perform skipping of PDCCH monitoring if a higher layer parameter which is related to a PDCCH skipping configuration is configured, or enable the wireless communication device to stop PDCCH monitoring during a skipping period if the higher layer parameter which is related to the PDCCH skipping configuration is configured. The search space switching indication field may be to enable or disable the wireless communication device to perform search space switching if a higher layer parameter which is related to search space switching configuration is configured.

Enabling the wireless communication device to stop PDCCH monitoring during the skipping period may comprise at least one of setting a duration parameter as 0 slot of a search space set, setting the skipping period as a PDCCH monitoring periodicity (ks) of a search space set, or setting the skipping period as a value configured by a higher layer parameter. The search space set may comprise at least one of all search space sets of a search space set group with a group index indicated by DCI or a current monitored search space set group, a Type-3 common search space set, or a UE-specific search space set configured in an active downlink (DL) bandwidth part (BWP). The skipping period may be a maximum PDCCH monitoring periodicity (ks) of search space sets in a SSS group.

At least one of the following may be satisfied: (i) the skipping flag field is at least 1 bit if the higher layer parameter related to PDCCH skipping or search space switching configuration may be configured, (ii) a SSS group index indication field may be used to indicate the skipping period, if the skipping flag field is set to configure the wireless communication device to perform skipping of PDCCH monitoring, (iii) the SSS group index indication field may be used to indicate the SSS group index, if the skipping flag field is set to configure the wireless communication device to perform search space set group switching or if the skipping flag field is 0 bit, (iv) the SSS group index indication field may be used to indicate the SSS group index, if the higher layer parameter related to PDCCH skipping configuration is not configured or if the skipping flag field is 0 bit, (v) the PDCCH skipping indication field may be at least 1 bit if the higher layer parameter related to PDCCH skipping configuration is configured, (vi) the search space switching indication field may be at least func(log 2(N)) bits if the higher layer parameter related to search space switching configuration is configured, (vi) the skipping flag field and the PDCCH skipping indication field may be each 0 bit when the higher layer parameter related to PDCCH skipping configuration is not configured, or (vii) the SSS group index indication field and the search space switching indication field may be each 0 bit when the higher layer parameter related to search space switching configuration is not configured. The PDCCH skipping indication field may be a same field as the search space switching indication field. The skipping flag field may be a same field as the SSS group index indication field. The higher layer parameters related to the PDCCH skipping configuration and the search space switching configuration may not be configured simultaneously for a wireless communication device.

In some embodiments, the PDCCH skipping may be applied for all downlink (DL) bandwidth parts (BWPs) in a cell or in all serving cells in a cell group. In some embodiments, the skipping period may be determined according to a reference subcarrier spacing (SCS) configuration, and the reference SCS configuration may be a smallest SCS configuration among all bandwidth parts (BWPs) in a serving cell or all serving cells in the cell group. In some embodiments, during the skipping period or during a specific duration, the wireless communication device may perform PDCCH monitoring for a scheduling retransmission data after the trigger event.

The specific duration may be related to at least one of the skipping period, a drx-RetransmissionTimerDL timer, a drx-RetransmissionTimerUL timer, a timer used for detecting a PDCCH for a scheduling retransmission data, a discontinuous reception (DRX) configuration, or a maximum number of data retransmission or repetition. The specific duration may be where the skipping period overlaps with at least one duration during which at least one of a drx-RetransmissionTimerDL timer or a drx-RetransmissionTimerUL timer is running when discontinuous reception (DRX) is configured. The specific duration may start after occurrence of a triggering event indicating skipping of PDCCH monitoring, and may extend to a time when data for retransmission is received successfully by the wireless communication device. The wireless communication device may perform skipping of PDCCH monitoring after the end of the specific duration.

In some embodiments, after the trigger event, the wireless communication device may not expect to monitor any PDCCH scheduling data for initial transmission, until the PDCCH monitoring behavior is changed by a next trigger event. In some embodiments, a timer related to search space set group switching may not be started, reset, counted or decremented when the wireless communication device switches from performing PDCCH monitoring to skipping of PDCCH monitoring. In some embodiments, at least two timers may be reset when the wireless communication device switches from a first SSS group to a second SSS group, for performing PDCCH monitoring, if N is larger than 2, and a group index of the second SSS group is smaller than a maximum group index configured by a higher layer parameter. The at least two timers may include at least one timer that is counted one after the wireless communication device detects a PDCCH and is reset as 0 after the timer is equal to the value configured by a higher layer parameter, or at least one timer that is decremented one after each slot and is reset as the value configured by a higher layer parameter after the timer is equal to 0.

In some embodiments, the wireless communication device may perform the PDCCH monitoring behavior from a first symbol or slot that is at least a time delay after the trigger event. The time delay may be determined according to a delay value corresponding to a processing capability reported by the wireless communication device. The processing capability may include a capability 1 with a delay value of 25 symbols, and a capability 2 with a delay value equal to 10 symbols for SCS=15 kHz, 12 symbols for SCS=30 kHz, and 22 symbols for SCS=60 kHz. If the wireless communication device is to perform bandwidth part (BWP) switching before or during the time delay, the time delay may be determined as a maximum value of the time delay and a BWP switching delay according to a reference subcarrier spacing (SCS) configuration. The reference SCS configuration may be determined by a smaller of a first SCS before the BWP switching and a second SCS after the BWP switching.

In some embodiments, if the wireless communication device is to perform bandwidth part (BWP) switching from a first BWP to a second BWP, before performing the PDCCH monitoring behavior responsive to the trigger event, the wireless communication device shall perform the PDCCH monitoring behavior in the second BWP. The search space set group or the skipping period, for performing the PDCCH monitoring behavior in the second BWP, may be determined according to a SSS group index or a skipping period index indicated by the trigger event. In some embodiments, the SSS group switching may be indicated by downlink control information (DCI) of DCI format 2-6, and the skipping of PDCCH monitoring may not be indicated by the DCI of DCI format 2-6. In some embodiments, performing the PDCCH monitoring configuration may include the wireless communication device performing the PDCCH monitoring according to a default search space set group predefined from the N SSS groups.

At least one aspect is directed to a system, method, apparatus, or a computer-readable medium. A wireless communication node may transmit, to a wireless communication device, plurality of control information. The wireless communication node may cause the wireless communication device to perform, responsive to a trigger event, a PDCCH monitoring configuration comprising at least one of performing PDCCH monitoring according to a search space set (SSS) group from N SSS groups or skipping of PDCCH monitoring according to a skipping period. The parameter N may be an integer greater than or equal to 2 and less than or equal to 10. The skipping period may be determined from one or more candidate skipping periods.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIGS. 3A and 3B show diagrams illustrating example PDCCH monitoring without and with DRX, respectively, in accordance with some embodiments of the present disclosure; and

FIGS. 4A and 4B show diagrams illustrating examples of a skipping scheme and a search space set (SSS) group switching scheme, respectively, in accordance with some embodiments of the present disclosure;

FIG. 5 shows a flowchart illustrating a method for control channel monitoring, in accordance with some embodiments of the present disclosure;

FIG. 6 shows a diagram depicting a framework of PDCCH monitoring adaptation, in accordance with some embodiments of the present disclosure;

FIGS. 7A-7D show diagrams illustrating various examples of timer-based SSS group switching are shown, in accordance with some embodiments of the present disclosure;

FIG. 8 shows diagrams illustrating various example implementation of a bit field to carry a SSS group skipping or PDCCH skipping indication, in accordance with some embodiments of the present disclosure;

FIG. 9 shows a diagram illustrating an example implementation of two bit fields for SSS group switching indication and PDCCH skipping indication, in accordance with some embodiments of the present disclosure; and

FIG. 10 shows diagrams illustrating various example implementations of a bit field to carry a SSS group skipping or PDCCH skipping indication, in accordance with some embodiments of the present disclosure.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

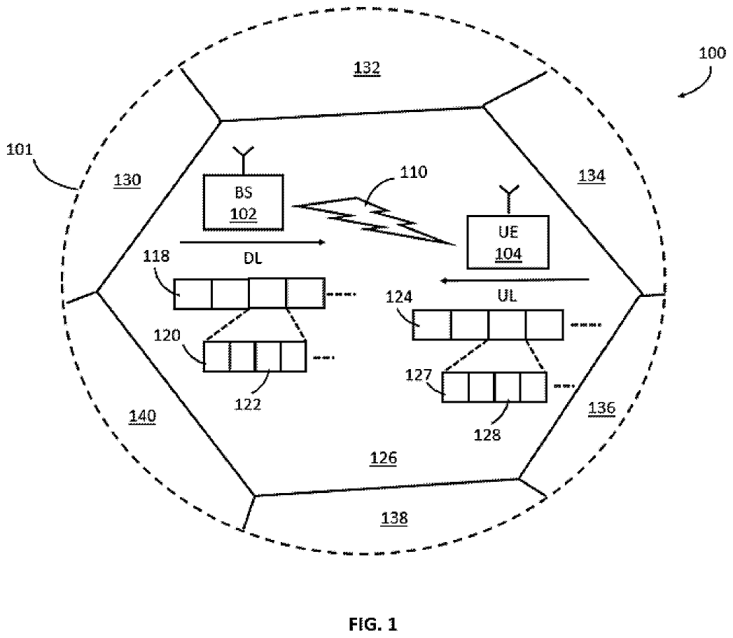

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127, which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

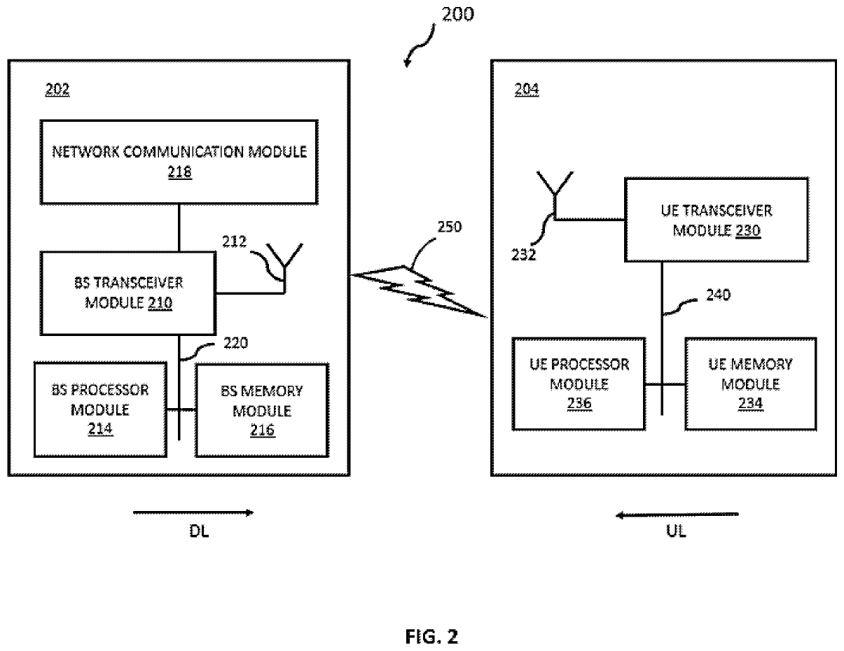

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein. As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Control Channel Monitoring

Existing communication systems, e.g., long-term evolution (LTE) and 5G new radio access technology (NR) communication systems, have many distinctive classes of use cases, such as enhanced mobile broadband (eMBB), massive machine type communication (mMTC) and ultra-reliable and low-latency communication (URLLC), among others. These use cases can be associated with respective requirements, such as higher data rate, higher reliability, lower latency and/or very low device energy (to support a longer battery life time), among others. Such requirements can be relevant to existing as well as other potential mobile communications, such as mobile communication associated with wearable devices, extended reality (XR) applications, cloud gaming, and/or augmented/virtual reality (AR/VR) applications, among others. With respect to the requirement of very low device energy, techniques for saving/reducing UE power consumption include discontinuous reception (DRX), downlink channel information (DCI) carrying wake-up indication (WUS), secondary cell (SCell) dormancy behavior and cross-slot scheduling (e.g., minimum applicable scheduling offset indication for the minimum applicable K0, the minimum applicable K2 and the minimum applicable value of aperiodic channel state information-reference signal (CSI-RS) triggering offset).

While the above described techniques reduce UE power consumption, control channel monitoring is one of the activities of the wireless communication device 104 or 204, also referred to herein as user equipment (UE), that still draws significant power. Specifically, the physical downlink control channel (PDCCH)-only state is found (or observed) to be the most power consuming activity by the wireless communication device 104 or 204. As used herein, the PDCCH-only state represents the behavior of monitoring a PDCCH not carrying a DCI by the wireless communication device 104 or 204. Accordingly, control channel monitoring calls for improved monitoring procedures to reduce respective UE power consumption.

In the existing long term evolution (LTE) and fifth generation (5G) new radio access technology (NR) communication systems, the wireless communication device 104 or 204 needs to know the uplink (UL) scheduling grant information for sending physical uplink shared channel (PUSCH) and downlink (DL) scheduling allocation information for receiving physical downlink shared channel (PDSCH). The information is included in the downlink control information (DCI) and is sent by the wireless communication node 102 or 202, also referred to herein as base station, to the wireless communication device 104 or 204 on the physical downlink control channel (PDCCH) in different DCI formats. As such, the wireless communication device 104 or 204 is configured to monitor the PDCCH.

Generally, the wireless communication device 104 or 204 monitors PDCCH in PDCCH monitoring occasions to avoid missing any UL/DL transmission information. The PDCCH monitoring occasion(s) can be determined by search space set (SSS) information element (IE), which includes a periodicity parameter kₛ, a duration parameter Tₛ within a periodicity and an offset parameter Oₛ associated with the start position of a periodicity. The discontinuous reception (DRX) mechanism and the wake-up indication allow the wireless communication device 104 or 204 to avoid some PDCCH monitoring power consumption during DRX Active Time.

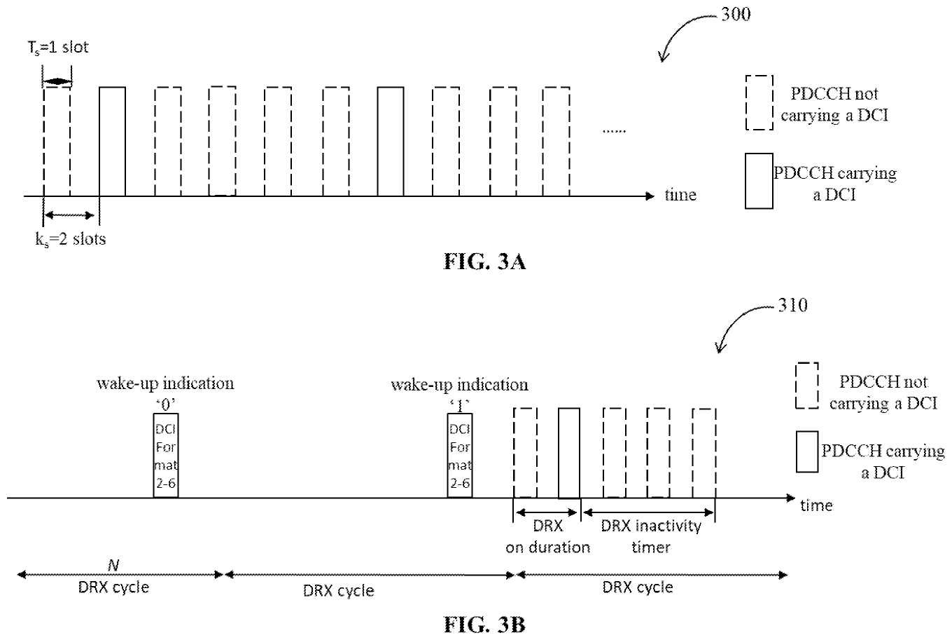

Referring to FIGS. 3A and 3B, diagrams 300 and 310 illustrating example PDCCH monitoring without and with DRX, respectively, are shown, in accordance with some embodiments of the present disclosure. FIG. 3A shows an example scenario of PDCCH monitoring without DRX. The PDCCH monitoring occasions are configured such that Tₛ=1 slot and kₛ=2 slots. In the example of FIG. 3B, the wireless communication device 104 or 204 performs PDCCH monitoring only during DRX Active Time, and responsive to the wake-up indication being set to 1. As such, the PDCCH monitoring shown in FIG. 3A consumes much more power than the PDCCH monitoring shown in FIG. 3B. Moreover, most of the power consumption associated with the PDCCH monitoring of FIG. 3B can be avoided, especially when the data arrival is relatively sparse and the DRX inactivity timer is relatively long.

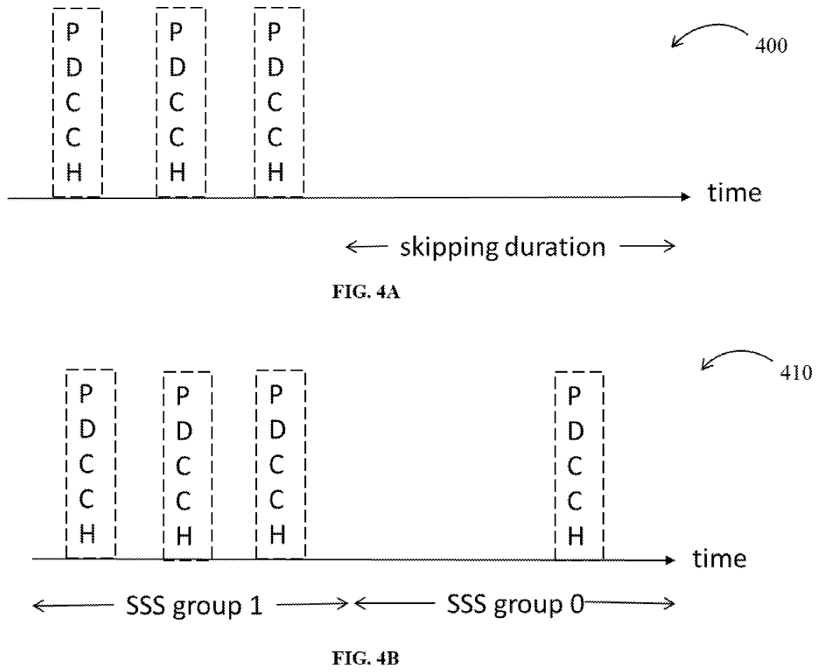

According to embodiments of the current disclosure, a first PDCCH skipping scheme can provide the wireless communication device 104 or 204 with a short duration during which to stop PDCCH monitoring, and therefore, reduce substantial power consumption in the PDCCH-only state. Moreover, the PDCCH switching scheme can trigger the wireless communication device 104 or 204 to change its PDCCH monitoring behavior to adapt to the real-time data scheduling to save power. For example, if there is no traffic arrival after a duration, the wireless communication device 104 or 204 can stop monitoring PDCCH frequently and start monitoring PDCCH sparsely by changing the SSS(s). Referring to FIG. 4A, a diagram 400 illustrating the skipping scheme is shown, in accordance with some embodiments of the present disclosure. The wireless communication device 104 or 204 may not perform PDCCH skipping during the skipping duration.

Another low-power PDCCH monitoring scheme is the PDCCH switching scheme, also referred to herein as the SSS group switching. Referring to FIG. 4B, a diagram 410 illustrating an example of the SSS group switching scheme is shown, in accordance with some embodiments of the present disclosure. The wireless communication device 104 or 204 may monitor the SSS group 0 when the data arrives relatively sparsely, and may monitor the SSS group 1 when the data arrives more frequently.

The two schemes may be applied in different situations. For example, when no data to the wireless communication device 104 or 204 is scheduled for a short or long duration, the PDCCH skipping scheme can reduce more power than the SSS group switching scheme because the wireless communication device 104 or 204 does not monitor any PDCCH occasion(s) during the skipping period. However, when the data arrival is relatively frequent or periodic for the wireless communication device 104 or 204, the SSS group switching scheme leads to more power reduction, especially when providing the wireless communication device 104 or 204 with SSS(s) having a suitable PDCCH periodicity kₛ and a suitable duration Tₛ. In the current disclosure, various embodiments that combine SSS group switching and PDCCH skipping to save UE power consumption are described.

The wireless communication device 104 or 204 may monitor the PDCCH on the control resource set and the PDCCH monitoring occasions for a search space set (SSS). The relevant monitoring parameters of the PDCCH can be included in the SearchSpace information element (IE), which is included in a radio resource control (RRC) signaling. The searchSpaceId and the controlResourceSetId included in the SearchSpace IE can indicate the SSS index and the index of CORESET applicable for the SearchSpace, respectively. The searchSpaceType included in SearchSpace IE can indicate the search space type of the PDCCH that the wireless communication device 104 or 204 has to monitor, which includes common search space and UE-Specific search space corresponding to different DCI formats. The DCI format 0-0 and 1-0, DCI format 2-0, DCI format 2-1, DCI format 2-2 and DCI format 2-3 are included in common search space. The DCI format 0-1 and 1-0, DCI format 0-1 and 1-1, DCI format 0-2, DCI format 1-2, DCI format 3-0 and/or DCI format 3-1 can be included in UE-Specific search space. For the UE supporting release 16, the DCI formats 2-4, 2-5 and/or 2-6 can also be included in the common search space, and the DCI formats 2-0 and 2-5 can be also included in the integrated access backhauling-mobile termination (IAB-MT) specific search space (MSS).

Each DCI format can have a corresponding unique usage. For example, the usages of DCI formats 0-0, 0-1 and 0-2 include scheduling of PUSCH in a cell. The usages of DCI formats 1-0, 1-1 and 1-2 include scheduling of PDSCH in a cell. One radio network temporary identifier (RNTI) can be used to scramble the cyclic redundancy check (CRC) of a DCI. The information of different functions in a DCI can be associated with different fields. The fields defined in the DCI formats are mapped to the information bits a₀ to aA−1. Each field is mapped in the order in which it appears in the description, including the zero-padding bit(s), if any, with the first field mapped to the lowest order information bit a₀, and each successive field can be mapped to higher order information bits. The most significant bit of each field can be mapped to the lowest order information bit for that field. For example, the most significant bit of the first field can be mapped to a₀.

The monitoringSlotPeriodicityAndOffset parameter included in the SearchSpace IE indicates the PDCCH monitoring periodicity of kₛ slots and the PDCCH monitoring offset of Oₛ slots. The duration parameter Tₛ included in the SearchSpace IE is a time duration satisfying Tₛ<kₛ indicating the number of slots when the wireless communication device 104 or 204 monitors the PDCCH for a SSS s. The field monitoringSymbolsWithinSlot Nsymb included in the SearchSpace IE indicates the first symbol(s) for PDCCH monitoring within a slot for PDCCH monitoring.

For the bit-mapping indication of the parameter monitoringSymbolsWithinSlot, the most significant (left) bit represents the first OFDM in a slot, and the second most significant (left) bit represents the second OFDM symbol in a slot and so on. The bit(s) set to one identify the first OFDM symbol(s) of the control resource set within a slot. For example, for DCI format 2_0, the first one symbol applies if the duration of CORESET (in the IE ControlResourceSet) identified by controlResourceSetId indicates three symbols, the first two symbols apply if the duration of CORESET identified by controlResourceSetId indicates two symbols, and the first three symbols apply if the duration of CORESET identified by controlResourceSetId indicates one symbol.

If the parameter monitoringSymbolsWithinSlot indicates PDCCH monitoring in a subset of up to three consecutive symbols that are the same in every slot where the wireless communication device 104 or 204 monitors PDCCH for all SSSs, the wireless communication device 104 or 204 may not expect to be configured with a PDCCH subcarrier spacing (SCS) other than 15 kHz if the subset includes at least one symbol after the third symbol. The wireless communication device 104 or 204 may not expect to be provided a first symbol and a number of consecutive symbols for a control resource set (CORESET) that results in a PDCCH candidate mapping to symbols of different slots. The wireless communication device 104 or 204 may not expect any two PDCCH monitoring occasions (MOs) on an active DL bandwidth part (BWP), for a same SSS or for different SSSs, in a same CORESET to be separated by a non-zero number of symbols that is smaller than the CORESET duration.

Specific PDCCH monitoring occasion(s) can be obtained as follows. For a search space set s, the wireless communication device 104 or 204 can determine that a PDCCH monitoring occasion exists in a slot with number n_{sf}^{μ} in a frame with number n_{f} if (n_{f}·Nₛₗₒₜ^{frame,μ}+n_{sf}^{μ}−Oₛ) mod kₛ=0. The wireless communication device 104 or 204 can monitor the PDCCH for search space set s for Tₛ consecutive slots starting from slot n_{sf}^{μ}, and may not monitor PDCCH for SSS s for the next kₛ−Tₛ consecutive slots.

When a DRX cycle is configured, the Active Time for Serving Cells in a DRX group includes the time while (i) drx-onDurationTimer or drx-InactivityTimer configured for the DRX group is running, (ii) drx-RetransmissionTimerDL or drx-RetransmissionTimerUL is running on any Serving Cell in the DRX group, (iii) ra-ContentionResolutionTimer or msgB-ResponseWindow is running, (iv) a Scheduling Request is sent on PUCCH and is pending, or (v) a PDCCH indicating a new transmission addressed to the C-RNTI of the MAC entity has not been received after successful reception of a Random Access Response for the Random Access Preamble not selected by the MAC entity among the contention-based Random Access Preamble.

The RRC may configure Serving in two groups. The RRC may not configure a secondary DRX group, in which case only one DRX group is configured. However, when two DRX groups are configured, RRC may configure each group of Serving Cells (also referred to herein as a DRX group) with a corresponding set of parameters including drx-onDurationTimer and drx-InactivityTimer. The two configured DRX groups can share the parameter values drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL and drx-HARQ-RTT-TimerUL.

The RRC may configure the MAC entity with a DRX functionality to control the PDCCH monitoring activity of the wireless communication device 104 or 204 for the MAC entity's C-RNTI, CI-RNTI, CS-RNTI, INT-RNTI, SFI-RNTI, SP-CSI-RNTI, TPC-PUCCH-RNTI, TPC-PUSCH-RNTI and TPC-SRS-RNTI. When applying DRX, the MAC entity can also monitor PDCCH according to the active time. When the wireless communication device 104 or 204 is in RRC_CONNECTED mode and DRX is configured for all the activated serving cells, the MAC entity may monitor the PDCCH discontinuously according to DRX.

For a Type3-PDCCH CSS (also referred to herein as Type-3 CSS) and UE-specific SSS (USS), the Type3-PDCCH CSS set can be configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, or CI-RNTI, and with C-RNTI, MCS-C-RNTI, CS-RNTI(s), or PS-RNTI for the primary cell. Also, a USS set can be configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL-L-CS-RNTI.

Power saving techniques for 5G NR can include the wake-up indication, the minimum applicable scheduling offset indication, the indication of dormancy-like behavior transition on Scell(s) and the SSS switching indication. The wake-up indication can be provided in DCI format 2-6 to indicate to the wireless communication device 104 or 204 to wake up, or not to wake up, in the next long DRX cycle. In response, the physical layer of the wireless communication device 104 or 204 can send the value to the MAC layer (higher layer) to determine whether to start, or not to start, the drx-onDuration timer in the next long DRX cycle. The minimum applicable scheduling offset indication can be provided in DCI format 0-1 or 1-1, and can be used to determine the minimum applicable K2 value for the active UL BWP, the minimum applicable K0 value for the active DL BWP, and the minimum applicable value of the aperiodic CSI-RS triggering offset for an active DL BWP. The minimum K2 parameter represents/denotes the minimum applicable value(s) for the time domain resource assignment (TDRA) table for PUSCH, and the minimum K0 parameter represents/denotes the minimum applicable value(s) for the TDRA table for PDSCH and for A-CSI RS triggering Offset(s). The value of K2 represents the slot offset between DCI and its scheduled PUSCH. The value of K0 represents the slot offset between DCI and its scheduled PDSCH. The value of A-CSI RS triggering offset(s) represents the offset between the slot containing the DCI that triggers a set of aperiodic non-zero power (NZP) CSI-RS resources and the slot in which the CSI-RS resource set is transmitted. The value of A-CSI RS triggering offset(s) caused the wireless communication device 104 or 204 to relax the PDCCH decoding process time to reduce some decoding power consumption.

The indication of dormancy-like behavior transition on secondary cell(s) can be provided via DCI formats 2-6, 0-1 and/or 1-1, and can trigger the wireless communication device 104 or 204 to perform dormancy behavior within some secondary cells. Responsive to the indication having a ‘0’ value for an activated SCell of the corresponding group of configured SCells, the wireless communication device 104 or 204 can switch from the non-dormant BWP to the dormant BWP for the SCell. Otherwise, upon receiving an indication set to a value of ‘1’ when a current active DL BWP is the dormant DL BWP, the wireless communication device 104 or 204 can switch from the dormant BWP to the non-dormant BWP for the SCell. The dormant BWP and the non-dormant BWP can be configured by a high layer (e.g., a layer higher than the physical layer) parameter.

The SSS switching indication can be provided in DCI format 2-0, and can include an index of a group, among two groups of SSSs, for PDCCH monitoring for scheduling on the serving cell. The wireless communication node 104 or 204 can perform PDCCH monitoring according to the SSSs with the indicated group index.

Embodiments described herein, or any combination thereof, can be applied in NR systems, for example, in relation with wearable devices, extended reality (XR) applications, cloud gaming and/or augmented/virtual reality (AR/VR) applications, among others. The embodiments can be applied in enhanced mobile broadband (eMBB) scenarios, massive machine type communication (mMTC) scenarios, ultra-reliable and low-latency communication (URLLC) scenarios and/or NR unlicensed band/spectrum (NR-U) scenarios, among others. Hereinafter, the PDCCH monitoring periodicity kₛ can also be referred to as the PDCCH monitoring cycle. The number of the monitoring occasions (MOs) within a slot for PDCCH monitoring is referred to as N_{MO}. The number of available PDCCH monitoring occasions within a slot (N_{symb}) can be determined using the configured monitoringSymbolsWithinSlot, the CORESET duration and one or more SSSs associated with the CORESET.

As used herein, a PDCCH monitoring behavior for the wireless communication device 104 or 204 can represent at least one of monitoring PDCCH according to a SSS, monitoring PDCCH according to SSS(s) within a SSS group, stopping monitoring PDCCH according to SSS(s) within a SSS group or stopping monitoring PDCCH during a skipping period. Also, PDCCH monitoring behavior transition and/or search space set group switching can represent the functionality including at least one of switching to monitor PDCCH according to another SSS, switching to monitor PDCCH according to another SSS group, switching to stop monitoring PDCCH according to another SSS or SSS group, switching to stop monitoring PDCCH during a skipping period or switching to monitor PDCCH according to another PDCCH monitoring configuration triggered by a change of one or more behaviors. Said another behavior can be related to the minimum applicable scheduling offset indication, carrier indicator, SCell dormancy indication and/or the wake-up indication. The skipping period can be configured for a DL active BWP, a SSS, a SSS group and/or a group of cells.

The SSS group switching capability supported by the wireless communication device 104 or 204 can be indicative of the capability of switching PDCCH monitoring behavior among multiple SSS groups, the SSS group ID being configured for the wireless communication device 104 or 204 and/or the wireless communication device 104 or 204 being configured to switch between SSS groups for all of serving cells in a cell group. The PDCCH skipping capability supported by the wireless communication device 104 or 204 can be indicative of at least one of the capability to stop monitoring PDCCH during one or more PDCCH monitoring periods according SSS(s), the capability to stop monitoring PDCCH during a skipping period, and/or the wireless communication device 104 or 204 being notified to stop monitoring PDCCH for all of serving cells in a cell group.

As used herein, the high-layer parameter can represent the radio resource control (RRC) signaling and/or the medium access control (MAC) signaling. The L1 signaling can represent the physical signaling or the downlink control signaling, e.g. a DCI carried by PDCCH. As used herein, the SSS group switching can be a general description representing (or indicative of) SSS switching, SSS group index switching, SSS group switching and/or a change of the value of ‘duration’ parameter in a SSS.

As used herein, the search space switching parameter represents at least one of the UE capability related to search space switching, the higher layer parameter related to search space set group switching, the higher layer parameter related to timer used for search space set group switching, or the higher layer parameter related to search space set group index. The PDCCH skipping parameter represents at least one of the UE capability related to PDCCH skipping, the higher layer parameter related to a skipping period, the higher layer parameter related to a timer used for PDCCH skipping, or the higher layer parameter related to PDCCH skipping.

As used herein, the search space switching (SSS) represents at least one of search space set group switching, the PDCCH monitoring behavior switching by switching the search space set group, the UE capability related to search space switching, the higher layer parameter related to search space set group switching, the higher layer parameter related to timer used for search space set group switching, or the higher layer parameter related to search space set group index. The PDCCH skipping represents at least one of the skipping of PDCCH monitoring, the PDCCH monitoring behavior by skipping PDCCH monitoring, the PDCCH monitoring behavior by skipping PDCCH monitoring according to a search space set group, the UE capability related to PDCCH skipping, the higher layer parameter related to a skipping period, the higher layer parameter related to a timer used for PDCCH skipping, or the higher layer parameter related to PDCCH skipping.

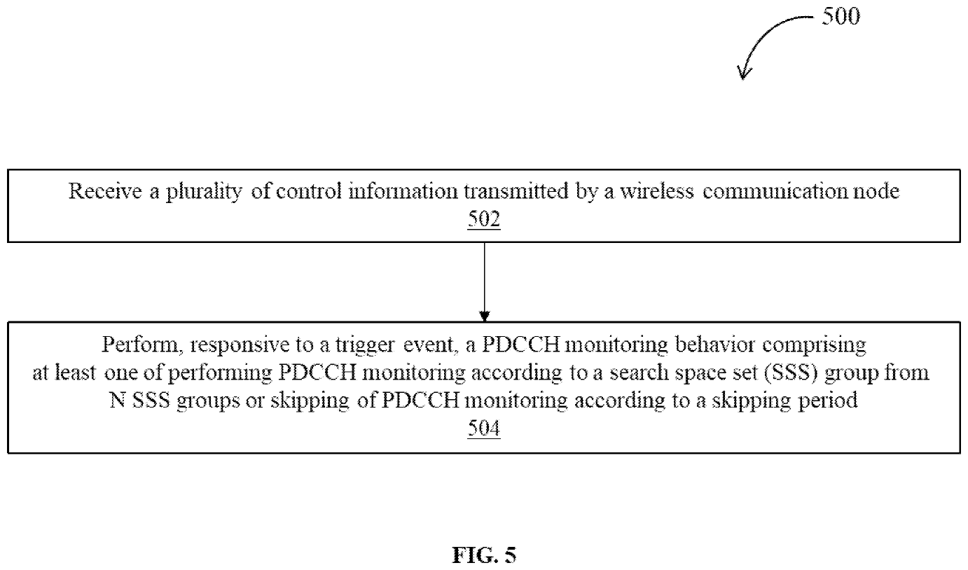

Referring to FIG. 5, a flowchart illustrating a method 500 for control channel monitoring is shown, in accordance with some embodiments of the present disclosure. The method 500 can include the wireless communication node 102 or 202, and the wireless communication device 104 or 204 receiving, a plurality of parameters or control information (STEP 502). The method 500 can include the wireless communication node 102 or 202 causing to perform, and the wireless communication device 104 or 204 performing, responsive to a trigger event, a PDCCH monitoring behavior (STEP 504). The PDCCH monitoring behavior can include at least one of performing PDCCH monitoring according to a search space set (SSS) group from N SSS groups or skipping of PDCCH monitoring according to a skipping period. The parameter N can be an integer greater than or equal to 2 and less than or equal to 10. The skipping period can be determined from one or more candidate skipping periods.

The method 500 can be performed according to various ways, embodiments and/or implementations. Such ways, embodiments and/or implementations are described in further detail in the following. It is to be noted that the embodiments or implementations described herein are provided for illustrative purposes, and they encompass other embodiments and/or implementations that can be deduced from the current disclosure.

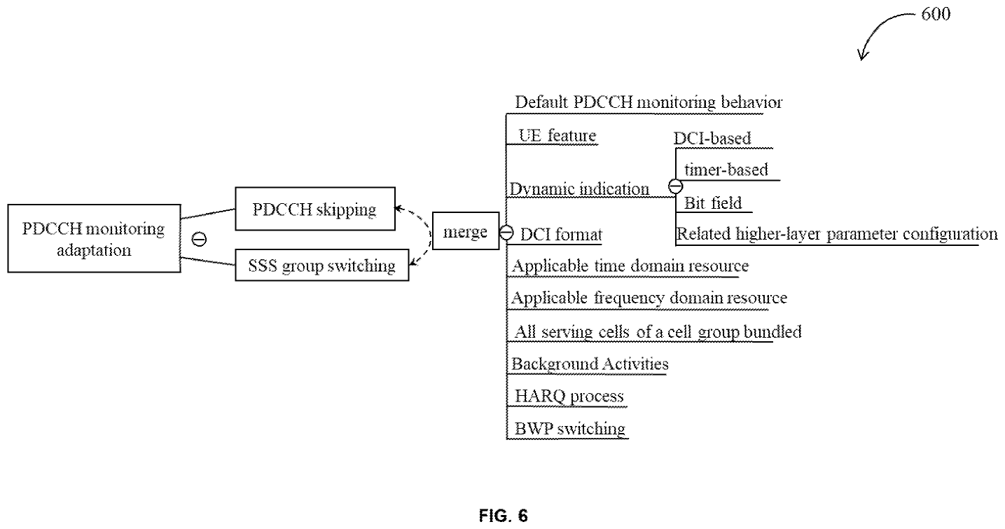

Referring to FIG. 6, a diagram 600 depicting a framework of PDCCH monitoring adaptation is shown, in accordance with some embodiments of the present disclosure. The diagram 600 depicts various embodiments and/or features associated with method 500. The PDCCH behavior performed by the wireless communication device 104 or 204 can include a combination of the PDCCH skipping scheme, or a version/embodiment/implementation thereof, and the SSS group switching scheme or a version/embodiment/implementation thereof. The wireless communication device 104 or 204 use any of these schemes alone or in combination according to various embodiments, implementations or features.

In some embodiments, if the wireless communication device 104 or 204 is provided (e.g., by the wireless communication node 102 or 202) a higher-layer parameter associated with SSS group switching, the wireless communication device 104 or 204 can be triggered to monitor PDCCH according to SSSs in a SSS group. The number of SSS groups can be denoted herein as N_{sw}. The parameter N_{sw} may not be smaller than 2 and may not be larger than 10. Each SSS group may have its own group index that is, for example, an integer between 0 and N_{sw}−1. In some implementations, the number of SSSs in a SSS group can be greater than or equal to 1.

In some embodiments, if the wireless communication device 104 or 204 is provided (e.g., by the wireless communication node 102 or 202) a higher-layer parameter associated with PDCCH skipping, the wireless communication device 104 or 204 can be triggered to stop monitoring PDCCH during a skipping period. The value of each skipping period may be greater than or equal to 1 slot. In some implementations, the skipping period can be equal to the PDCCH monitoring periodicity of a SSS. In some implementations, the DCI can include an indication to the wireless communication device 104 or 204 to stop monitoring PDCCH during a period. The DCI may cause the wireless communication device 104 or 204 to assume the duration of a SSS as 0 during a period. The period can include, or can be, at least one of a PDCCH monitoring periodicity of a SSS with duration Tₛ=0, a PDCCH monitoring periodicity of a SSS with or associated with PDCCH skipping configuration, the largest PDCCH monitoring periodicity among the SSSs within a SSS group, the smallest PDCCH monitoring periodicity among the SSSs within a SSS group or a a skipping period.

As depicted in FIG. 6, the wireless communication node 102 or 202 can trigger/cause the wireless communication device 104 or 204 to perform the PDCCH monitoring behavior in various ways. For instance, the triggering can be DCI-based, timer-based, via a bit field or using a related higher-layer parameter configuration, among others.

According to a first embodiment, the wireless communication device may start a default PDCCH monitoring behavior after a PDCCH monitoring behavior. The PDCCH monitoring behavior may include at least one of PDCCH monitoring according to a SSS group with a specific group index, the end of a skipping period, a timer expires, PDCCH monitoring according to a SSS, RRC configuration, RRC reconfiguration of SSS switching parameter and/or PDCCH skipping parameter.

The default PDCCH monitoring behavior or default SSS group may be determined based on at least one of the parameters including
a search space switching configuration related to a user equipment (UE) capability,
a PDCCH skipping configuration related to a UE capability,
a higher layer parameter used to enable SSS group switching,
a higher layer parameter used to enable PDCCH skipping,
a search space set group index configuration,
a PDCCH skipping parameter that is set to configure the wireless communication device to perform skipping of PDCCH monitoring,
a search space switching parameter that is set to configure the wireless communication device to perform search space set group switching,
a timer for search space switching,
a timer for PDCCH monitoring behavior switching,
a skipping period configuration,
a discontinuous reception (DRX) configuration,
a frequency band comprising at least one of: FR1, FR2, or an unlicensed band,
a transmission mode comprising at least one of: dynamic downlink (DL) scheduling, dynamic uplink (UL) scheduling, semi-persistent scheduling physical downlink shared channel (PDSCH), UL transmission without dynamic grant, quasi-periodic DL data scheduling with jitter, quasi-periodic UL data scheduling with jitter, or UL grant scheduling, or
a quality of service (QoS) parameter, or
a downlink control information (DCI) format comprising at least one of: DCI format 2-0, DCI format 0-1, DCI format 0-2, DCI format 1-1, DCI format 1-2, or DCI format 2-6.

The UE capability comprises an indication of whether the wireless communication device supports at least one of:
switching among N groups of search space sets with a DCI format monitoring, where N is not less than 2;
skipping PDCCH monitoring during the skipping period with a DCI format monitoring,
monitoring of a DCI format with a search space set switching field or a PDCCH skipping field,
at least a timer to switch to performing skipping PDCCH monitoring during a skipping period,
at least a timer to switch back to an original search space set group,
switching a search space set group with PDCCH decoding to a group other than group 0,
switching search space set groups for different cells independently, unless the wireless communication device supports search space switching for a set of cells, or
skipping PDCCH monitoring during the skipping period for different cells independently, unless the wireless communication device supports skipping PDCCH monitoring for a set of cells.

A UE capability for supporting switching among N groups of search space sets (SSSs) and a UE capability for supporting skipping PDCCH monitoring may not be enabled simultaneously.

The wireless communication device 104 or 204 can acquire/receive/obtain, e.g., from the wireless communication node 102 or 202, a higher-layer parameter associated with SSS group switching and/or PDCCH skipping, and in response, can reset PDCCH monitoring according to a first default SSS group. The wireless communication device 104 or 204 may start monitoring PDCCH according to a second default SSS group from the first slot after the end of the skipping period.

In some implementations, the first or second default SSS group may be the SSS group according to which the wireless communication device 104 or 204 may start monitoring the PDCCH after the wireless communication device 104 or 204 detects any PDCCH during a timer period. In some implementations, the first or second default SSS group may be the SSS group according to which the wireless communication device 104 or 204 may start monitoring the PDCCH if there is no PDCCH detected by the wireless communication device 104 or 204 during a timer period and until the timer expires.

In some implementations, the first default SSS group and the second default SSS group may have the same SSS group index. The first and/or second default SSS group may be one of the SSS groups configured for the wireless communication device 104 or 204, or the BWP. The index of the first and/or second default SSS group may be equal to 0 or N_{sw}−1. In some implementations, the first default SSS group and the second default SSS group may have different group indices. The first default SSS group may have a larger group index than the second default SSS group.

In some implementations, the SSS group switching and/or the PDCCH skipping may be limited to USS set and/or Type-3 CSS set. In NR, after RRC configuration or reconfiguration, the wireless communication device 104 or 204 may have to monitor PDCCH during a Type-3 CSS set associated with CORESET0. For RRC configuration or reconfiguration of the SSS group switching and/or PDCCH skipping parameters, the wireless communication device 104 or 204 may monitor PDCCH according to a default SSS group. The default SSS group may have to take into consideration the Type-3 CSS set associated with CORESET0.

In some implementations, upon receiving/acquiring/obtaining (e.g., from the wireless communication node 102 or 202) a RRC signaling to support the search space switching and/or the PDCCH skipping, the wireless communication device 104 or 204 may reset the PDCCH monitoring according to a default SSS group. After RRC configuration or reconfiguration and upon receiving/acquiring/obtaining (e.g., from the wireless communication node 102 or 202) a RRC signaling to support the search space switching and/or the PDCCH skipping and a default SSS group, the wireless communication device 104 or 204 may reset the PDCCH monitoring according to the default SSS group.

In some implementations, the default SSS group may at least include the Type-3 CSS set associated with CORESET0. The default search space set group may represent all of the SSSs configured in the current active BWP for the wireless communication device 104 or 204. The default SSS group may be the SSS group with a group index equal to N_{sw}−1.

In some implementations, the SSS group switching and/or the PDCCH skipping may be limited to USS set and/or Type-3 CSS set except for the Type-3 CSS set associated with CORESET0. Upon receiving/acquiring/obtaining (e.g., from the wireless communication node 102 or 202) a RRC signaling to support the search space switching and/or the PDCCH skipping, the wireless communication device 104 or 204 may perform the default PDCCH monitoring behavior or monitor PDCCH according to a default SSS group. The default PDCCH monitoring behavior or default SSS group may be determined using (or based on) at least one of the factors including frequency band, traffic model, scheduling DCI format, the PDCCH monitoring behavior before starting default PDCCH monitoring behavior or monitor PDCCH according to a default SSS group. The frequency band can include at least one of the frequency range 1 (FR1) and frequency range 2 (FR2) in NR and NR unlicensed band (NR-U). The traffic model can include at least one of a dynamic DL scheduling, a DL semi-persistent scheduling, a quasi-periodic DL (or UL data scheduling with a jitter) or a persistent scheduling. The scheduling DCI format can include at least one of the DCI format 2-0, DCI format 0-1, DCI format 0-2, DCI format 1-1 and/or DCI format 1-2. The PDCCH monitoring behavior can include at least PDCCH monitoring according to SSS group with a specific group index, PDCCH skipping, PDCCH monitoring according to a SSS, RRC configuration and/or RRC reconfiguration.

According to a second embodiment, the wireless communication device 104 or 204 and/or the wireless communication node 102 or 202 may employ a timer-based triggering approach to trigger a specific PDCCH monitoring behavior. The timer-based triggering approach may be applicable when the wireless communication device 104 or 204 is or is not provided by RRC signaling to enable the wireless communication device 104 or 204 to change PDCCH monitoring behavior triggered by a DCI.

In some implementations, the wireless communication device 104 or 204 may stop monitoring PDCCH according to a SSS group with group index i, and start monitoring PDCCH according to another SSS group with group index j if the wireless communication device 104 or 204 detects a PDCCH during a first timer period. The wireless communication device 104 or 204 may stop monitoring PDCCH according to a SSS group with index j and start monitoring PDCCH according to another SSS group with group index i if the wireless communication device 104 or 204 does not detect any PDCCH during a first timer period and until the first timer expires. The wireless communication device 104 or 204 may stop monitoring PDCCH according to a SSS group with group index j and start monitoring PDCCH according to another SSS group with group index k if the wireless communication device 104 or 204 detects a PDCCH during a second timer period. The wireless communication device 104 or 204 may stop monitoring PDCCH according to a SSS group with index k and start monitoring PDCCH according to another SSS group with group index j if the wireless communication device 104 or 204 does not detect any PDCCH during a second timer period and until the second timer expires.

In some implementations, the group index i may be smaller than the group index j. The group index j may be smaller than the group index k. The first timer may be larger than the second timer. The timer period may represent the duration that the timer is incremented or decremented by after each slot based on a reference SCS configuration. The reference SCS may be the smallest SCS configuration among all configured DL BWPs in the serving cell or in the set of serving cells.

In some implementations, if the timer for SSS group switching is configured, the wireless communication device 104 or 204 may reset the timer upon (or responsive to) detecting a PDCCH before the timer expires. The PDCCH detected by the wireless communication device 104 or 204 may belong to USS set and/or Type-3 CSS set. There may be multiple timers decremented by the wireless communication device 104 or 204 upon starting PDCCH monitoring according to a SSS group with a specific group index. The specific group index may be larger than 0 and smaller than the maximum group index (e.g., N_{sw}−1). The values of the multiple timers may be different from each other.

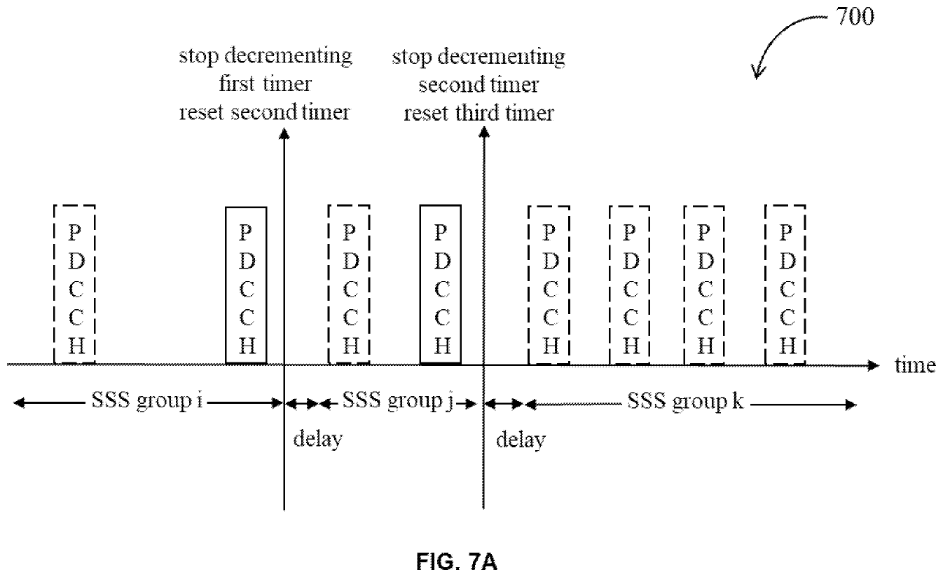

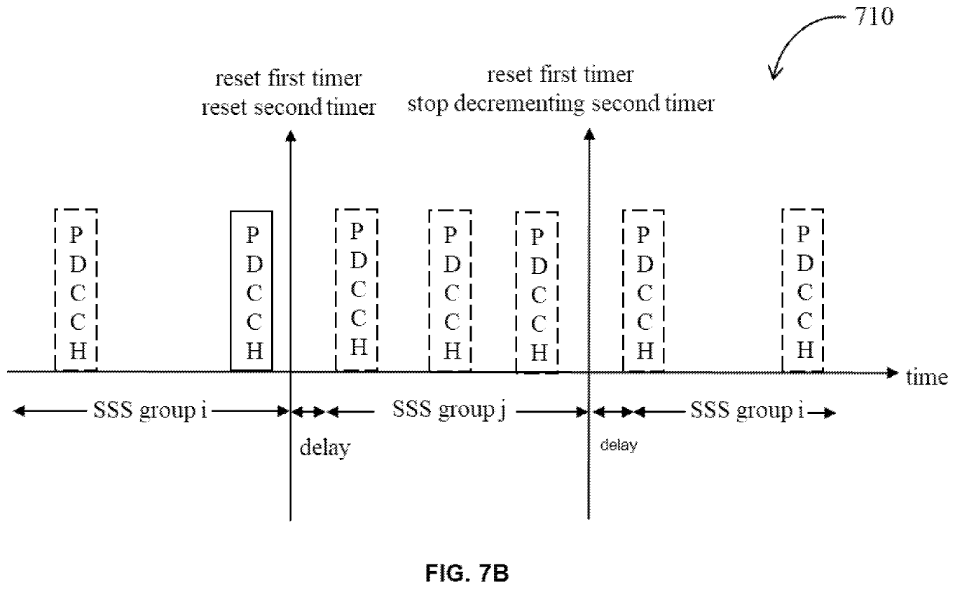

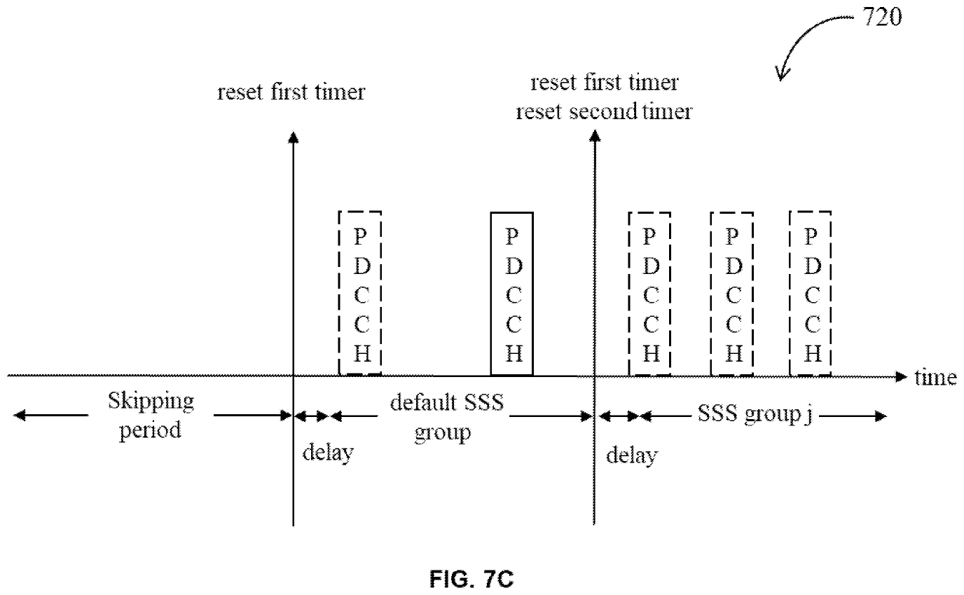

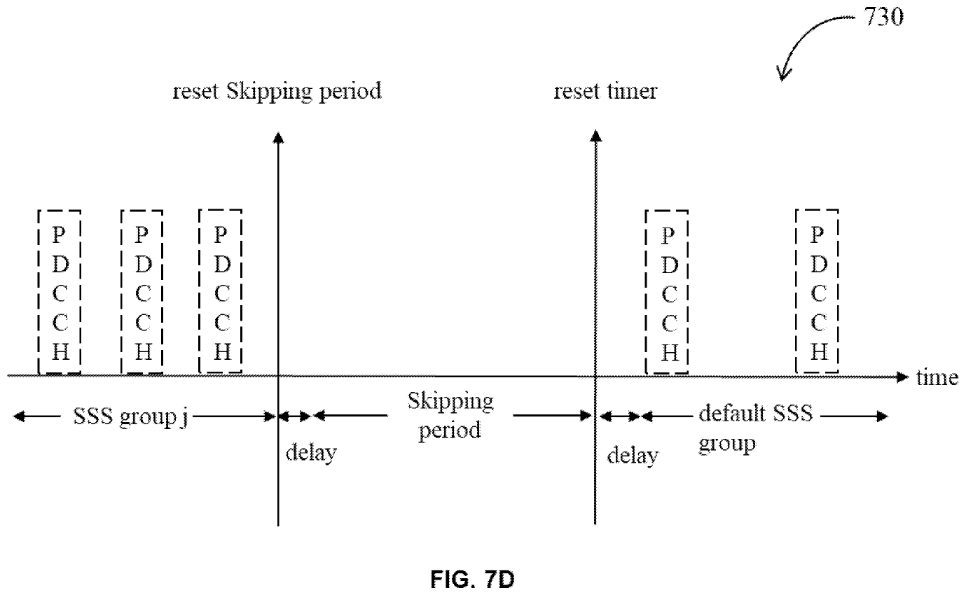

Referring now to FIGS. 7A-7D, diagrams 700, 710, 720 and 730 illustrating various examples of timer-based SSS group switching are shown, in accordance with some embodiments of the present disclosure. In the example of FIG. 7A, when monitoring PDDCH according to SSS group i, the wireless communication device 104 or 204 may stop PDCCH monitoring according to SSS group i, and then start monitoring the PDCCH according to SSS group j. The wireless communication device 104 or 204 may start monitoring the PDCCH according to SSS group j from the first slot that is at least a delay after the last symbol of the PDCCH with the DCI format. The wireless communication device 104 or 204 may stop decrementing a first timer and set a second timer using a value configured by a higher-layer parameter, upon the wireless communication device 104 or 204 detects a DCI format by monitoring PDCCH in any SSS.

When monitoring PDDCH according to SSS group j, the wireless communication device 104 or 204 may stop monitoring PDCCH according to SSS group j and start monitoring PDCCH according to SSS group k. The wireless communication device 104 or 204 may start the PDCCH monitoring according to SSS group k from the first slot that is at least a delay after the last symbol of the PDCCH with the DCI format. The wireless communication device 104 or 204 may stops decrementing the second timer and set a third timer using a value configured by the higher-layer parameter, upon detecting a DCI format by monitoring PDCCH in any SSS. The first timer is larger than the second timer, and the second timer may not be smaller than the third timer. The group index i may be smaller than group index j, and the group index j may be smaller than group index k.

In the example of FIG. 7B, when monitoring PDDCH according to SSS group i, the wireless communication device 104 or 204 may stop monitoring PDCCH according to SSS group i, and start monitoring PDCCH according to SSS group j. PDCCH monitoring according to SSS group j may start from the first slot that is at least a delay after the last symbol of the PDCCH with the DCI format. The wireless communication device 104 or 204 may reset the first timer and set the second timer using values configured by higher-layer parameters, upon detecting a DCI format by monitoring PDCCH in any SSS. The wireless communication device 104 or 204 may reset the first timer and/or the second timer using (or according to) the values configured by higher-layer parameters upon detecting a PDCCH before the first timer or the second timer expires, respectively.

When monitoring PDDCH according to SSS group j, the wireless communication device 104 or 204 may stop monitoring PDCCH according to SSS group j, and start monitoring PDCCH according to SSS group i. The PDCCH monitoring according to SSS group i may start from/at the first slot that is at least a delay after the last slot when/where the first timer expires. The wireless communication device 104 or 204 may reset the first timer using (or according to) the values configured by higher-layer parameters and stop decrementing the second timer, if the wireless communication device 104 or 204 does not detect a DCI format by monitoring PDCCH in any search space set. If the wireless communication device 104 or 204 is monitoring PDDCH according to SSS group j, the wireless communication device 104 or 204 may keep monitoring PDCCH according to SSS group j if the first timer did not expire, or even after the last slot where/when the second timer expires. If the wireless communication device 104 or 204 is monitoring PDDCH according to SSS group i, the wireless communication device 104 or 204 may keep monitoring PDCCH according to SSS group i if the second timer does not expired, or even after the last slot where/when the first timer expires.

In the example of FIG. 7C, the wireless communication device 104 or 204 may start monitoring PDDCH according to a default SSS group from/at the first slot that that is at least a delay after the last slot of the skipping period. The default SSS group may have a group index i. The wireless communication device 104 or 204 may set the first timer using (or according to) a value configured by a higher-layer parameter at the time when (or upon) the skipping period ends. When monitoring PDDCH according to SSS group i, the wireless communication device 104 or 204 may switch to monitoring PDCCH according to SSS group j (e.g., stop PDCCH monitoring according to SSS group i) from/at the first slot that is at least a delay after the last symbol of the PDCCH with the DCI format. The wireless communication device 104 or 204 may reset the first timer and set the second timer using (or according to) values configured by higher-layer parameters, if the wireless communication device 104 or 204 detects a DCI format by monitoring PDCCH in any SSS.

In the example of FIG. 7D, the wireless communication device 104 or 204 may start skipping monitoring PDDCH according to a SSS group i from/at the first slot that that is at least a delay after a trigger event. The trigger event includes at least one of the detection of a DCI indicating the PDCCH skipping, or a timer expires. The timer is used for search space switching, and/or PDCCH skipping. The default SSS group may have a group index larger than i or have a group index j. The wireless communication device 104 or 204 may set the skipping period using (or according to) a value configured by a higher-layer parameter at the time when (or upon) the skipping period starts. After the end of the skipping period, the wireless communication device 104 or 204 may switch to monitoring PDCCH according to a default SSS group. The wireless communication device 104 or 204 may reset a timer configured by higher-layer parameters, if the wireless communication device 104 or 204 detects a DCI format by monitoring PDCCH in any SSS. The skipping period and the timer may be configured by a same higher layer parameter related to search space switching parameter.

In some implementations, when the wireless communication device 104 or 204 is monitoring PDDCH according to SSS group i, the wireless communication device 104 or 204 may stop monitoring PDCCH according to SSS group i and start to skip monitoring PDCCH during a skipping period from the first slot that is at least a delay for PDCCH skipping after the last symbol of the PDCCH with the DCI format. The wireless communication device 104 or 204 may stop decrementing the first timer, upon detecting a DCI format with a PDCCH skipping indication.

When monitoring PDDCH according to SSS group i, the wireless communication device 104 or 204 may stop monitoring PDCCH according to search space set group i, and start to skip monitoring PDCCH during a skipping period that may start at the first slot after the first timer expires. The wireless communication device 104 or 204 may stop decrementing the first timer.

In some implementations, when monitoring PDCCH according to SSS group j, the wireless communication device 104 or 204 may stop monitoring PDCCH according to the SSS group j, and start monitoring PDCCH according to the SSS group i if the wireless communication device 104 or 204 does not detect any PDCCH until the timer i expires. When monitoring PDCCH according to SSS group j, the wireless communication device 104 or 204 may stop monitoring PDCCH according to the SSS group j and start monitoring PDCCH according to the SSS group k if the wireless communication device 104 or 204 detects a PDCCH before the timer j expires. The PDCCH detected by the wireless communication device 104 or 204 may belong to a USS set and/or Type-3 CSS set. The group index k may be larger than group index j, and the group index j may be larger than group index i. The timer i may not be smaller than the timer j.

The PDCCH monitoring frequency of the SSS group with group index i may be smaller than that of the SSS group with group index j. The PDCCH monitoring frequency of the SSS group j may be smaller than that of the SSS group k. When the PDCCH monitoring frequency of a SSS group is higher, it means that the total number of slots that the wireless communication device 104 or 204 needs to monitor PDCCH during a fixed time is more.

In some implementations, the PDCCH monitoring behavior where the wireless communication device 104 or 204 starts monitoring PDCCH according to the SSS group i may represent/imply that the wireless communication device 104 or 204 can stop monitoring PDCCH during a skipping period. The skipping period may be the maximum PDCCH monitoring periodicity kₛ of the SSSs in SSS group i. The wireless communication device 104 or 204 may stop decrementing any timer for SSS group switching during a skipping period.

In some implementations, if the wireless communication device 104 or 204 stops monitoring PDCCH according to a SSS group or start performing PDCCH skipping during the skipping period, the wireless communication device 104 or 204 may not apply the timer during the skipping period. For example, the wireless communication device 104 or 204 may reset (or may not reset) the timer and/or stop decrementing or incrementing the timer if the wireless communication device 104 or 204 starts skipping monitoring PDCCH during the skipping period.

According to a third embodiment, the wireless communication device 104 or 204 and/or the wireless communication node 102 or 202 may employ a DCI-based triggering approach to trigger a specific PDCCH monitoring behavior. The number of skipping period values configured by the higher-layer parameter(s) may be denoted as Nₛₖ. The number of SSS groups configured by higher-layer parameter(s) may be N_{sw}.

In some implementations, the skipping flag field in a DCI is used to enable the wireless communication device to perform PDCCH skipping, if the PDCCH skipping parameter is configured for the wireless communication device. The skipping flag field in a DCI is used to enable the wireless communication device to perform search space set group switching, if the search space switching parameter is configured for the wireless communication device. The skipping flag field may be at least 1 bit if the higher layer parameter related to PDCCH skipping or search space switching is configured.

In some implementations, the search space set group index indication field is used to indicate the search space set group index, if the search space switching parameter is configured for the wireless communication device, the skipping flag is set to enable the UE to perform SSS group switching, and/or the number of different search space set group index is larger than 1. The search space set group index indication field can be used to indicate the skipping period, if the PDCCH skipping parameter is configured for the wireless communication device, and/or the skipping flag is set to enable the UE to perform PDCCH skipping, and/or the number of different values of skipping period is larger than 1.

In some implementations, the UE performs PDCCH skipping by setting the duration parameter of search space set as 0 slot, or by stopping monitoring PDCCH during a skipping period.

In some implementations, the skipping period is at least one of a smallest PDCCH monitoring periodicity or a largest PDCCH monitoring periodicity in the unit of slot among all of the search space sets in a SSS group, or a timer used for search space set switching in the unit of millisecond, or a duration configured by RRC signaling.

In some implementations, if search space switching parameter and PDCCH skipping parameter is configured for the wireless communication device 104 or 204, the PDCCH skipping and SSS group switching can be indicated by a bit field in a DCI. The bit field may include at least 1 bit if the SSS group switching and/or PDCCH skipping are configured. The bit field may include 0 bit if both the SSS group switching and PDCCH skipping are not configured.

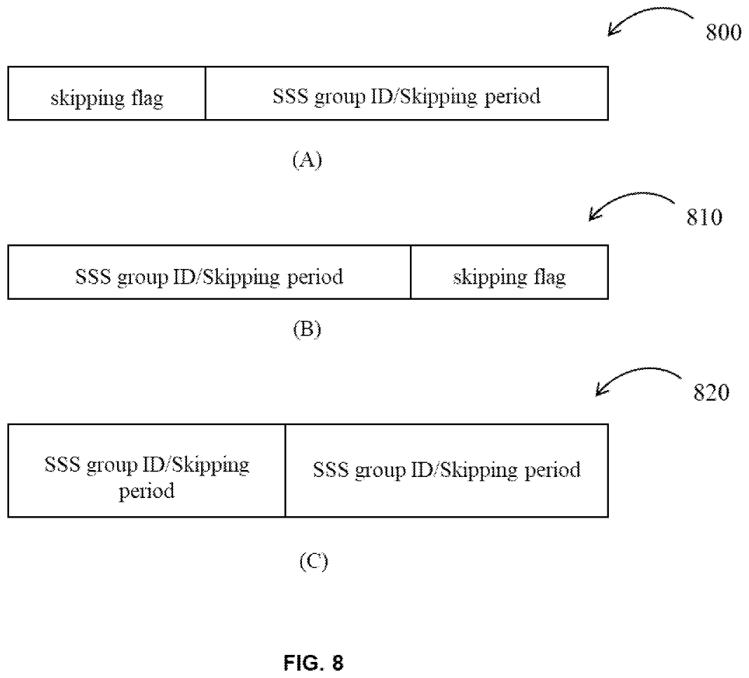

In some implementations, when the wireless communication device 104 or 204 receives/acquires/obtains (e.g., from the wireless communication node 102 or 202) a PDCCH skipping parameter, the bit field may include one bit to enable the PDCCH skipping for the wireless communication device 104 or 204. The one bit can be viewed as a skipping flag. Referring to FIG. 8, diagrams 800, 810 and 820 illustrating various example implementations of a bit field to carry a SSS group skipping or PDCCH skipping indication are shown, in accordance with some embodiments of the present disclosure. In the diagram 800, the skipping flag is located at the first bit location of the bit field, whereas in diagram 810, the skipping flag is located at the last bit location of the bit field. In the example of diagram 820, the skipping flag is one of the bits used to indicate the SSS group index.

The skipping flag may be used to enable the wireless communication device 104 or 204 to stop PDCCH monitoring during a skipping period. For instance, when the skipping flag field in a DCI is set to ‘0’, the wireless communication device 104 or 204 may not perform PDCCH skipping. However, when the skipping flag field in the DCI is set to ‘1’, the wireless communication device 104 or 204 may perform PDCCH skipping during the skipping period. In cases where the wireless communication device 104 or 204 is provided by more than one skipping period configured by RRC signaling, the wireless communication device 104 or 204 may determine the skipping period by the indication of the bit field.

In some implementations, when the PDCCH skipping parameter is not configured, the bit field representing the skipping flag may be 0 bit. That is, no bits are allocated for the bit field. However, when the PDCCH skipping parameter is configured, the field representing the skipping flag may be 1 bit. In some implementations, if the skipping flag is set to ‘0’ and SSS group switching is configured, the field of SSS group ID/skipping period may be used to indicate SSS group index. If the skipping flag is set to ‘1’, the field of SSS group ID/skipping period may be used to indicate skipping duration.

In some implementations, the skipping flag may be used to enable the wireless communication device 104 or 204 to set the duration of a SSS as 0 slot. In some implementations, if the skipping flag is set to ‘0’ and the SSS group switching is configured, the wireless communication device 104 or 204 may stop monitoring PDCCH according to current SSS group and start monitoring PDCCH according to the SSS group indicated by the field of SSS group ID. If the skipping flag is set to ‘1’, the wireless communication device 104 or 204 may set the ‘duration’ of the current monitored SSSs as 0 slot and stop monitoring PDCCH according to current SSSs during the skipping period.

The SSSs may belong to the Type-3 CSS set and/or USS set. The skipping period may not be larger than the parameter of PDCCH monitoring periodicity kₛ of any of the current SSSs. If the skipping flag is set to ‘1’ and the SSS group switching is configured, the wireless communication device 104 or 204 may stop monitoring PDCCH according to current SSS group, set the ‘duration’ of the SSSs in the indicated SSS group as 0 slot, and stop monitoring PDCCH according to the SSS group indicated by the field of SSS group ID during the skipping period. The skipping period may not be larger than the parameter of PDCCH monitoring periodicity kₛ of any of the SSSs in the search space set group.

In some implementations, if the skipping flag is set to ‘0’ and N_{sw}=2, the skipping flag can be used to indicate one of the two SSS group indices. If the skipping flag is set to ‘0’ and N_{sw}=2, the skipping flag can be used to indicate the SSS group index 0. If the skipping flag is set to ‘0’ and N_{sw}=2, the skipping flag can be used to indicate the SSS group with index 1.

In some implementations, if the skipping flag is set to ‘1’ and the Nₛₖ>1, the bits after the skipping flag can be used to determine the skipping period value. The number of bits can be equal to ceil(log₂(Nₛₖ)). In some embodiments, if the skipping flag is set to ‘1’ and the Nₛₖ=1, the skipping flag can be used to indicate the skipping period and the bit field can include only one bit.

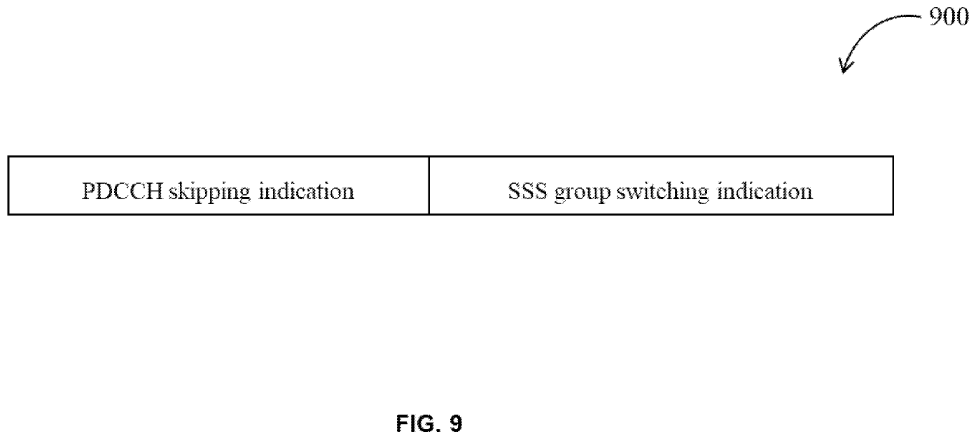

In some implementations, the bit field of PDCCH skipping and SSS group switching can have adjacent bit locations in a DCI. Referring to FIG. 9, a diagram 900 illustrating an example implementation of two bit fields for SSS group switching indication and PDCCH skipping indication is shown, in accordance with some embodiments of the present disclosure. In FIG. 9, the PDCCH skipping indication and the SSS group switching indication have adjacent bit locations in a DCI. In some implementations, if PDCCH skipping parameter is not configured, the bit width of PDCCH skipping indication can be 0 bit. If SSS group switching is not configured, the bit width of SSS group switching indication can be 0 bit.

In some implementations, the skipping flag can be used to enable the UE to set the duration of a SSS as 0 slot. If the skipping flag is set to ‘0’, the field of PDCCH skipping may include a 1 bit for skipping flag indication. If the skipping flag is set to ‘1’, the UE may set the ‘duration’ of the current monitored SSS to 0 slot, and stop monitoring PDCCH according to current SSSs. The SSSs can belong to the Type-3 CSS set and USS set. In some implementations, if the skipping flag is set to ‘1’ and the SSS group switching is configured, the UE may stop monitoring PDCCH according to a current SSS group, and set the ‘duration’ of the SSSs in the indicated SSS group as 0 slot and start to skip (or abort) monitoring PDCCH during the skipping period. The skipping period may not be larger than the parameter of PDCCH monitoring periodicity kₛ of any of the SSSs in the SSS group.

In some implementations, the PDCCH skipping and/or SSS group switching can be jointly indicated by both DCI format 2-0, a DCI format 0_x and DCI format 1_x. If the PDCCH skipping parameter is configured for a wireless communication device supporting NR, the ‘COT duration indicator’ field in DCI format 2-0 for a wireless communication device supporting NR-U can be used to indicate the skipping period for the wireless communication device supporting NR. If the SSS group switching is configured for the wireless communication device supporting NR, the SSS group switching flag field in DCI format 2-0 for wireless communication device supporting NR-U can be used to indicate the SSS group switching for the wireless communication device supporting NR.

In some implementations, if the SSS group switching is configured and the DCI format 2-0 indicates a SSS group with group index 1, the DCI format 0_1, DCI format 0_2, DCI format 1_1 and/or DCI format 1_2 can indicate the to the wireless communication device to perform SSS subgroup switching. The SSSs in each SSS subgroup can belong to the SSSs in the SSS group with group index 1. When provided with SSS group switching, the wireless communication device 104 or 204 can reset the PDCCH monitoring according to the search space set group with group index 1. When provided with a timer for SSS group switching, the wireless communication device 104 or 204 can reset the timer and decrement the timer after each one slot according to a reference SCS. In some implementations, the SSS group switching can be indicated by DCI format 2-6, and the PDCCH skipping cannot be indicated by DCI format 2-6.

According to a fourth embodiment, the wireless communication device 104 or 204 and/or the wireless communication node 102 or 202 may employ RRC configuration to trigger a specific PDCCH monitoring behavior. In some implementations, the PDCCH skipping may be configured per cell group. For instance, if the PDCCH skipping bundled for a cell group is configured, the wireless communication device 104 or 204 may stop monitoring PDCCH during a skipping period in each cell of the cell group after the wireless communication device 104 or 204 detects a DCI indicating a PDCCH skipping in one of the cells configured in the cell group. The one of the cells configured in the cell group may be a primary cell (PCell), primary secondary cell (PSCell) and/or a special cell (SpCell).

When provided by the PDCCH skipping for a cell or bundled for a cell group, the wireless communication device 104 or 204 can assume the skipping period according to the reference SCS configuration. The reference SCS can be the smallest SCS configuration among all BWPs in the serving cell or all serving cells in a cell group. If the PDCCH skipping parameter is configured per BWP and the wireless communication device 104 or 204 is to switch BWP during a skipping period, the wireless communication device 104 or 204 may stop skipping PDCCH monitoring after BWP switching if the PDCCH is not configured in the switched BWP.

In some implementations, if the PDCCH skipping parameter is configured per search space set, the wireless communication device 104 or 204 may set the duration of the SSS to 0 slot and stop monitoring PDCCH during one PDCCH monitoring periodicity if the PDCCH skipping parameter is enabled by a DCI indication and the wireless communication device 104 or 204 is monitoring PDCCH according to the SSS. In some implementations, the wireless communication device 104 or 204 may set the duration Tₛ of at least one of the search space sets as 0 slot if the PDCCH skipping parameter is configured in the active BWP and the PDCCH skipping is enabled by a DCI indication. In some embodiments, the DCI indication represents the skipping flag field in a DCI is set as ‘1’.

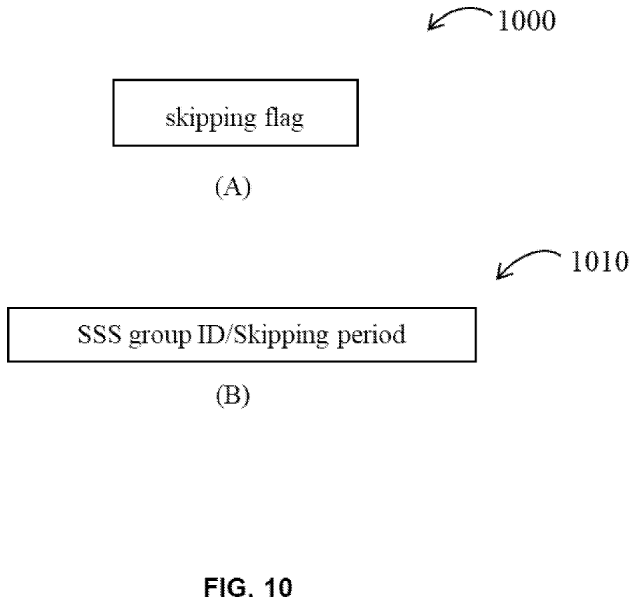

In some implementations, the bit field of skipping flag or SSS group ID/skipping period can have bit location in a DCI. Referring to FIG. 10, a diagram 1000 illustrating an example implementation of one bit field for SSS group switching indication and PDCCH skipping indication is shown, in accordance with some embodiments of the present disclosure. In FIG. 10, the skipping flag indication or the SSS group ID/skipping period indication have its bit location in a DCI. In some implementations, if PDCCH skipping parameter is configured, the bit width of skipping flag can be larger than 0 bit and is used for PDCCH skipping indication. Otherwise, if search space switching is configured, the bit width of skipping flag can be larger than 0 bit and is used for SSS group switching indication. Otherwise, the bit width of SSS group ID/skipping period can be 0 bit. In some implementations, if search space switching is configured, the bit width of SSS group ID/skipping period can be larger than 0 bit and is used for SSS group switching indication. Otherwise, if PDCCH skipping parameter is configured, the bit width of SSS group ID/skipping period can be larger than 0 bit and is used for PDCCH skipping indication. Otherwise, the bit width of SSS group ID/skipping period can be 0 bit.

In some implementations, the SSS group switching can be triggered by an indication in a DCI. The indication can be used to indicate the UL/DL data transmission for the wireless communication device supporting XR application. The RRC configuration of SSS group switching for wireless communication device supporting NR-U can be reused for SSS group switching for the wireless communication device supporting NR.

A fifth embodiment can include determining switching delay, triggering based on cross-carrier scheduling and/or BWP switching. In some implementations, the wireless communication device 104 or 204 can stop monitoring PDCCH according to the current SSS group, start monitoring PDCCH according to the switched SSS group from the first slot that is at least a delay after the timer triggering or the DCI indicating PDCCH monitoring according to the switched SSS group. The timer-based or DCI-based triggering can be as discussed above with regard to the second and third embodiments. In some implementations, if the wireless communication device 104 or 204 is not to perform BWP switching during the delay, the delay may be determined as discussed below. The minimum delay values 1 and 2 provided in Table 1 below can represent UE processing capabilities 1 and 2, respectively, and can be indicative of values for a wireless communication device supporting NR-U.

TABLE 1
Minimum value of delay.

| | Minimum delay | Minimum delay |
|---|---|---|
| μ | value 1 [symbols] | value 2 [symbols] |
| 0 | 25 | 10 |
| 1 | 25 | 12 |
| 2 | 25 | 22 |

In some implementations, if the wireless communication device 104 or 204 is to perform BWP switching during the delay, the delay can be determined as the maximum value of the delay in Table 1 and BWP switching delay in Table 2 configured by higher layer parameters according to the reference SCS configuration. The reference SCS configuration may be determined by the smaller SCS between before BWP switch and the SCS after BWP switch. The reference SCS configuration may be determined by the smallest SCS among all BWPs on a serving cell or all serving cells in a cell group.

TABLE 2
BWP switch delay.

| | | BWP switch delay T_{BWPswitchDelay} (slots) | |
|---|---|---|---|
| μ | NR Slot length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the smaller SCS between the SCS before BWP switch and the SCS after BWP switch.

In some implementations, if the wireless communication device 104 or 204 is monitoring PDCCH, or starts monitoring PDCCH, according to a SSS group and the wireless communication device 104 or 204 is triggered by a cross-carrier scheduling, the wireless communication device 104 or 204 may keep monitoring PDCCH according to a SSS group in the scheduled cell that has the same group index as the SSS group in the scheduling cell if the SSS group switching is configured for the scheduled cell. If the wireless communication device 104 or 204 is monitoring PDCCH, or starts monitoring PDCCH, according to a SSS group and the wireless communication device 104 or 204 is triggered to perform a BWP switch, the wireless communication device 104 or 204 may keep monitoring PDCCH according to a SSS group in the BWP after the BWP switch that has the same group index as the SSS group in the BWP before BWP switch if the search space set group switching is configured for the BWP before BWP switch.

In some embodiments, if the wireless communication device 104 or 204 stops monitoring PDCCH or performs PDCCH skipping during a skipping period and the wireless communication device 104 or 204 is triggered a BWP switch, the wireless communication device 104 or 204 may keep stopping monitoring PDCCH or performing PDCCH skipping in the BWP after BWP switch that has the same group index as the search space set group or the same skipping period order ID in the BWP before BWP switch if the PDCCH skipping is configured for the BWP before BWP switch. In some implementations, if the wireless communication device 104 or 204 stops monitoring PDCCH or performs PDCCH skipping during a skipping period and the wireless communication device 104 or 204 is triggered a cross-carrier scheduling during the skipping period, the wireless communication device 104 or 204 may keep stopping monitoring PDCCH or performing PDCCH skipping in the scheduled cell that has the same group index with the search space set group or the same skipping period order ID in the scheduling cell if the PDCCH skipping is configured for the scheduled cell. In some implementations, the SSS group switching and PDCCH skipping can be applied for at least SCS configuration with value 0, 1 and 2.

According to a sixth embodiment, other approaches for PDCCH skipping can be used for SSS group switching. In some implementations, if the wireless communication device 104 or 204 is notified or instructed to stop monitoring PDCCH during a skipping period, the wireless communication device 104 or 204 may not expect to be scheduled PDSCH/PUSCH during the skipping period, except if the PDSCH/PUSCH is a retransmission. If the PDCCH skipping is indicated by the DCI, the wireless communication device 104 or 204 may start to skip monitoring PDCCH after there is no data retransmission for the wireless communication device 104 or 204. The no data retransmission can represent that there is no unfinished HARQ processing task for the wireless communication device 104 or 204, or all scheduled data before receiving the DCI indicating PDCCH skipping are received or transmitted successfully, or all scheduled data including the data scheduled by the DCI indicating PDCCH skipping are received or transmitted successfully.

In some implementations, during the time where the skipping period overlapped with drx-RetransmissionTimerDL and/or drx-RetransmissionTimerUL, the UE can keep monitoring PDCCH scheduling data for retransmission which is not received successfully before receiving the PDCCH skipping indication, if the higher-layer parameter associated with it (retransmission period) is configured.

In some implementations, during a specific duration, the wireless communication device performs PDCCH monitoring for a scheduling retransmission data after a trigger event. Wherein the trigger event is used to trigger the wireless communication device to perform PDCCH skipping or search space set group switching.

In some implementations, the specific duration is related to at least one of:
the skipping period, or
a drx-RetransmissionTimerDL timer, or
a drx-RetransmissionTimerUL timer, or
a timer used for detecting a PDCCH for a scheduling retransmission data, or
a discontinuous reception (DRX) configuration, or
a maximum number of data retransmission or repetition.

In some implementations, the specific duration starts after occurrence of a triggering event indicating skipping of PDCCH monitoring or search space set group switching, and extends to a time when data for retransmission is received successfully by the wireless communication device. The wireless communication device performs skipping of PDCCH monitoring or search space set group switching after the end of the specific duration.

In some implementations, the specific duration is where the skipping period overlaps with at least one duration during which at least one of: a drx-RetransmissionTimerDL timer or a drx-RetransmissionTimerUL timer is running when discontinuous reception (DRX) is configured.

In some implementations, the wireless communication device does not expect to monitor PDCCH with data scheduling for initial transmission after detecting a PDCCH with PDCCH skipping indication.

In some implementations, if the wireless communication device 104 or 204 detects a DCI indicating PDCCH skipping, the wireless communication device 104 or 204 can start performing PDCCH skipping after a reserved duration. The reserved duration may start from/at the slot after receiving the DCI indicating PDCCH skipping. The value of the reserved duration may be the required time to complete a data transmission with a maximum number of retransmission. The value of the reserved duration may be configured by a higher-layer parameter. If there is some uncompleted data transmission until the end of the reserve duration, the wireless communication device 104 or 204 may ignore the PDCCH skipping indication.

In some implementations, if DRX is configured and the wireless communication device 104 or 204 may perform PDCCH skipping with the skipping period overlapped with the DL/UL data retransmission time or drx-RetransmissionTimerDL and/or drx-RetransmissionTimerUL. The wireless communication device 104 or 204 may keep monitoring PDCCH during the retransmission time or drx-RetransmissionTimerDL and/or drx-RetransmissionTimerUL.

In some implementations, if the DRX is configured and the wireless communication device 104 or 204 is provided by PDCCH skipping configured by RRC signaling, the wireless communication device 104 or 204 may keep monitoring PDCCH during the drx-RetransmissionTimerDL and/or drx-RetransmissionTimerUL if the higher-layer parameter is configured to enable wireless communication device 104 or 204 to monitor PDCCH for retransmission purpose. If the DRX is configured and the wireless communication device 104 or 204 is provided by PDCCH skipping configured by RRC signaling, the wireless communication device 104 or 204 may not keep monitoring PDCCH during the drx-RetransmissionTimerDL and/or drx-RetransmissionTimerUL if the higher-layer parameter is not configured to enable or is configured not to enable the UE to monitor PDCCH for retransmission purpose.

In some implementations, if the wireless communication device 104 or 204 is provided by SSS group switching and/or PDCCH skipping for a serving cell or serving cells in a cell group, the same search space set group index and/or the skipping period value can be configured for all BWPs or serving cells in a cell group.

The various embodiments described above and in the claims can be implemented as computer code instructions that are executed by one or more processors of the wireless communication device (or UE) 104 04 204 or the wireless communication node 102 or 202. A computer-readable medium may store the computer code instructions.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a plurality of parameters; and
performing, by the wireless communication device responsive to a trigger event, a PDCCH monitoring behavior comprising at least one of: PDCCH monitoring according to a search space set (SSS) group from N SSS groups or skipping of PDCCH monitoring according to a skipping period, based on the plurality of parameters,
wherein the skipping period is determined from one or more candidate skipping periods.

2. The method of claim 1, wherein the plurality of parameters comprise at least one of:
a search space switching configuration related to a first capability of the wireless communication device, or
a PDCCH skipping configuration related to a second capability of the wireless communication device.

3. The method of claim 2, wherein the at least one of the first or second capability comprises an indication of whether the wireless communication device supports at least one of:
switching among N groups of search space sets with a DCI format monitoring, where N is not less than 2; or
skipping PDCCH monitoring during the skipping period with a DCI format monitoring.

4. The method of claim 1, wherein the trigger event comprises at least one of:
the wireless communication device being provided a time occurring after a last slot or symbol or the end of the skipping period;
receiving, by the wireless communication device from the wireless communication node, a signaling indicative of the change of PDCCH monitoring behavior; or
occurrence of a predefined condition related to a timer at the wireless communication device.

5. The method of claim 4, comprising:
determining, by the wireless communication device, that the signaling includes a downlink control information (DCI) indication.

6. The method of claim 5, wherein the DCI indication includes:
a skipping flag field to perform at least one of:
enable or disable the wireless communication device to perform skipping of PDCCH monitoring if a higher layer parameter which is related to PDCCH skipping configuration is configured; or
enable or disable the wireless communication device to perform search space set (SSS) group switching if a higher layer parameter which is related to SSS switching is configured.

7. The method of claim 5, wherein the DCI indication includes at least one of:
a PDCCH skipping indication field to perform at least one of:
enable or disable the wireless communication device to perform skipping of PDCCH monitoring if a higher layer parameter which is related to a PDCCH skipping configuration is configured; or
enable the wireless communication device to stop PDCCH monitoring during a skipping period if the higher layer parameter which is related to the PDCCH skipping configuration is configured;
a search space switching indication field to enable or disable the wireless communication device to perform search space switching if a higher layer parameter which is related to search space switching configuration is configured; or
a search space set group index if the higher layer parameter which is related to search space switching configuration is configured.

8. The method of claim 6, wherein
the skipping flag field is at least 1 bit if the higher layer parameter related to PDCCH skipping or search space switching configuration is configured; or
a search space switching group index indication field is used to indicate the search space switching group index, if the skipping flag field is set to configure the wireless communication device to perform search space set group switching or if the skipping flag field is 0 bit.

9. The method of claim 7, wherein at least one of:
the PDCCH skipping indication field is at least 1 bit if the higher layer parameter related to PDCCH skipping configuration is configured; or
the PDCCH skipping indication field is a same field as the search space switching indication field.

10. The method of claim 1, wherein:
if the wireless communication device is to perform bandwidth part (BWP) switching from a first BWP to a second BWP, before performing the PDCCH monitoring behavior responsive to the trigger event, the wireless communication device shall perform the PDCCH monitoring behavior in the second BWP,
wherein the search space set group or the skipping period, for performing the PDCCH monitoring behavior in the second BWP, is determined according to a SSS group index or a skipping period index indicated by the trigger event.

11. A wireless communication device comprising:
at least one processor configured to:
receive, via a receiver from a wireless communication node, a plurality of parameters; and
perform, responsive to a trigger event, a PDCCH monitoring behavior comprising at least one of: PDCCH monitoring according to a search space set (SSS) group from N SSS groups or skipping of PDCCH monitoring according to a skipping period, based on the plurality of parameters,
wherein N is an integer and the skipping period is determined from one or more candidate skipping periods.

12. The wireless communication device of claim 11, wherein the plurality of parameters comprise at least one of:
a search space switching configuration related to a first capability of the wireless communication device, or
a PDCCH skipping configuration related to a second capability of the wireless communication device.

13. The wireless communication device of claim 12, wherein at least one of the first or second capability comprises an indication of whether the wireless communication device supports at least one of:
switching among N groups of search space sets with a DCI format monitoring, where N is not less than 2; or
skipping PDCCH monitoring during the skipping period with a DCI format monitoring.

14. The wireless communication device of claim 11, wherein the trigger event comprises at least one of:
the wireless communication device being provided a time occurring after a last slot or symbol or the end of the skipping period;
the wireless communication device receiving, from the wireless communication node, a signaling indicative of the change of PDCCH monitoring behavior; or
occurrence of a predefined condition related to a timer at the wireless communication device.

15. The wireless communication device of claim 14, wherein the at least one processor is configured to:
determine that the signaling includes a downlink control information (DCI) indication.

16. The wireless communication device of claim 15, wherein the DCI indication includes:
a skipping flag field to perform at least one of:
enable or disable the wireless communication device to perform skipping of PDCCH monitoring if a higher layer parameter which is related to PDCCH skipping configuration is configured; or
enable or disable the wireless communication device to perform search space set (SSS) group switching if a higher layer parameter which is related to SSS switching is configured.

17. The wireless communication device of claim 15, wherein the DCI indication includes at least one of:
a PDCCH skipping indication field to perform at least one of:
enable or disable the wireless communication device to perform skipping of PDCCH monitoring if a higher layer parameter which is related to a PDCCH skipping configuration is configured; or
enable the wireless communication device to stop PDCCH monitoring during a skipping period if the higher layer parameter which is related to the PDCCH skipping configuration is configured;
a search space switching indication field to enable or disable the wireless communication device to perform search space switching if a higher layer parameter which is related to search space switching configuration is configured; or
a search space set group index if the higher layer parameter which is related to search space switching configuration is configured.

18. The wireless communication device of claim 16, wherein
the skipping flag field is at least 1 bit if the higher layer parameter related to PDCCH skipping or search space switching configuration is configured; or
a search space switching group index indication field is used to indicate the search space switching group index, if the skipping flag field is set to configure the wireless communication device to perform search space set group switching or if the skipping flag field is 0 bit.

19. The wireless communication device of claim 17, wherein at least one of:
the PDCCH skipping indication field is at least 1 bit if the higher layer parameter related to PDCCH skipping configuration is configured; or
the PDCCH skipping indication field is a same field as the search space switching indication field.

20. The wireless communication device of claim 1, wherein:
if the wireless communication device is to perform bandwidth part (BWP) switching from a first BWP to a second BWP, before performing the PDCCH monitoring behavior responsive to the trigger event, the wireless communication device shall perform the PDCCH monitoring behavior in the second BWP,
wherein the search space set group or the skipping period, for performing the PDCCH monitoring behavior in the second BWP, is determined according to a SSS group index or a skipping period index indicated by the trigger event.
